(19) United States
(12) Patent Application Publication
(10) Pub. No.: US 2020/0299579 A1
(43) Pub. Date: Sep. 24, 2020

(54) LIQUID CRYSTAL MEDIUM AND LIGHT MODULATION ELEMENT

(71) Applicant: MERCK PATENT GMBH, DARMSTADT (DE)

(72) Inventors: Simon SIEMIANOWSKI, Rossdorf (DE); Rachel TUFFIN, Darmstadt (DE); Ian SAGE, Malvern (GB)

(73) Assignee: MERCK PATENT GMBH, DARMSTADT (DE)

(21) Appl. No.: 16/765,619

(22) PCT Filed: Nov. 19, 2018
(86) PCT No.: PCT/EP2018/081674

§ 371 Date: May 20, 2020

(30) Foreign Application Priority Data
Nov. 21, 2017 (EP) 17202672.6

(51) Int. Cl. C09K 19/30

(52) U.S. Cl. CPC C09K 19/3003; C09K 2019/0466

(57) ABSTRACT

The invention relates to a liquid crystal medium comprising one or more dielectrically negative compounds and one or more dielectrically positive compounds, characterized in that the medium as a whole exhibits a dielectrically anisotropy (Δε) in the range from −0.25 to +0.25. Furthermore, the invention relates to a method of production of such medium and to the use of such medium in a light modulation element utilizing flexoelectric switching.

Moreover, the invention relates to a light modulation element utilizing flexoelectric switching comprising the described medium, to a method of production of such light modulation element, to the use of such light modulation element in electro-optical devices and to these electro-optical devices as such.

### TECHNICAL FIELD

The invention relates to a liquid crystal medium comprising one or more dielectrically negative compounds and one or more dielectrically positive compounds, characterized in that the medium as a whole exhibits a dielectrically anisotropy (Δε) in the range from −0.25 to +0.25. Furthermore, the invention relates to a method of production of such medium and to the use of such medium in a light modulation element utilizing flexoelectric switching.

Moreover, the invention relates to a light modulation element utilizing flexoelectric switching comprising the described medium, to a method of production of such light modulation element, to the use of such light modulation element in electro-optical devices and to these electro-optical devices as such.

### STATE OF THE ART

Liquid Crystal Displays (LCDs) are widely used to display information. LCDs are used for direct view displays, as well as for projection type displays. The electro-optical mode, which is employed for most displays still, is the twisted nematic (TN)-mode with its various modifications. Besides this mode, the super twisted nematic (STN)-mode, more recently the optically compensated bend (OCB)-mode, the electrically controlled birefringence (ECB)-mode with their various modifications, as e. g. the vertically aligned nematic (VAN), the patterned ITO vertically aligned nematic (PVA)-, the polymer stabilized vertically aligned nematic (PSVA)-mode, the multi domain vertically aligned nematic (MVA)-mode, as well as others, have been increasingly used.

In general, nematic liquid crystal displays (LCD) are operated based on dielectric switching, i.e. the coupling between dielectric anisotropy (Δε) of the liquid crystal and an applied electric field, which gives rise to an electro-optic response. This response is quadratic with the applied field, i.e. it is not polar, and arises from the switching of the liquid crystal molecules by the field. In conventional nematic LCDs, the switching of the liquid crystal molecules takes place in a plane containing the direction of the applied electric field, which means that an electric field is applied across a liquid crystal sandwich cell, will switch the molecules out-of-plane, i.e. in a plane perpendicular to the cell substrates. This kind of switching, however, gives an electro-optic response having a contrast strongly dependent on the viewing angle.

Besides the above-mentioned modes there are also electro-optical modes employing an electrical field substantially parallel to the substrates, respectively the liquid crystal layer, like e.g. the In Plane Switching (short IPS) mode (as disclosed e.g. in DE 40 00 451 and EP 0 588 568) and the Fringe Field Switching (FFS) mode. Especially the latter mentioned electro-optical modes, which have good viewing angle properties and good response times, are increasingly used for LCDs for modern desktop monitors and even for displays for TV and for multimedia applications.

Further to the above-mentioned display modes, new display modes have been proposed exploiting the so-called “flexoelectric” effect.

The flexoelectric effect was first discussed as a liquid crystal analogue to the piezoelectric effect in R. B. Meyer, Phys. Rev. Lett. 1969, 22, 918-921.

Flexoelectricity is the generation of a spontaneous polarization in a liquid crystal due to a deformation of the director, or conversely, the deformation of the director due to an applied electric field, which is also called flexoelectric switching.

Typically, the flexoelectric effect arises from molecules with a shape asymmetry. The first cases to be considered were wedge and banana shaped molecules. Wedge shaped molecules with longitudinal dipoles show spontaneous polarization when splayed. Likewise, banana shaped molecules with transverse dipoles exhibit spontaneous polarization under bend deformation.

In the above cases, the polarization couples to a splay and/or bend deformation. It can be seen from symmetry arguments that the twist deformation cannot give rise to a polarization. Thus, a phenomenological formula for the flexoelectric polarization (P_{f}) can be written as

P_{f}=e₁n(div n)+e₃(curl n)×n

where θ₁ and θ₃ are the splay, bend flexoelectric coefficients, and n (div n), and (curl n)×n are the splay and bend vectors respectively.

For example, Takezoe et al. describe in Liquid Crystals, 36, 2009, 1119-1124 an experimental method for the determination of the flexoelectric coefficients. For this purpose, the authors suggested the use of a bent-core compound of the following formula,

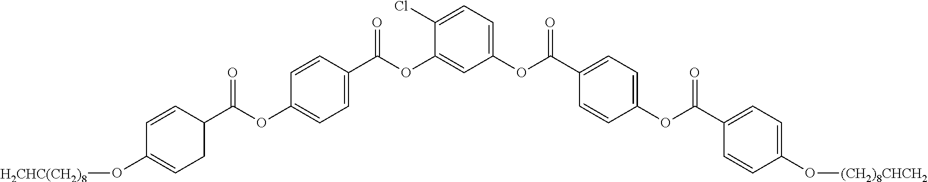

This compound was introduced into a homeotropically aligned cell, which contained two parallel 12 μm thick strips of aluminium foil serving as spacers and electrodes with a gap of 2 mm.

When a DC field is applied transversely through the homeotropic cell, a coupling between the induced flexoelectric polarisation (P_{f}) and an external electric field (E) can be observed, which leads to the bending deformation of the director, the so-called converse flexoelectric effect.

The relation of the physical parameters involved in this effect can be expressed as

$$δ n = \frac{{e}_{3}^{2}}{{K}_{33}^{2}} {E}^{2} {n}_{o} ( 1 - \frac{{n}_{o}^{2}}{{n}_{e}^{2}} ) \frac{{d}^{3}}{24} ,$$

where δn is the induced birefringence, K₃₃ the bend elastic constant, E the strength of the applied field, d the thickness of the liquid-crystalline medium layer, and nₒ, nₑ are the ordinary and extraordinary refractive indices, respectively.

Furthermore, WO 2005/071477 A1 discloses a liquid crystal device comprising a flexoelectric liquid crystal bulk layer, wherein an inhomogeneous electric field in a direction substantially parallel to the substrates is generated by an interdigitated electrode pattern. It is preferred that the average polarization direction in a direction parallel to the substrates in field-off state is orthogonal to the direction in which an electric field is to be generated. In this case, both the rise and the fall times become field-dependent and the total response time is thereby decreased.

Moreover, WO 2008/104533 A1 discloses a hybrid aligned nematic LC mode (HAN). The liquid-crystalline molecules, which are sandwiched between two substrates, align perpendicular to one substrate surface, but parallel to the other substrate surface. This surface orientation is fixing. The two substrates require different alignment layers. In the HAN arrangement, such a deformation is induced caused by the different surface orientations of the liquid-crystalline molecules at the two substrate surfaces and by the elastic forces among the individual liquid-crystalline molecules (due to a continuous transition from parallel to perpendicular orientation across the thickness of the liquid-crystalline molecule layer), so that a flexoelectric polarisation is generated.

If an in-plane field is applied, the liquid-crystalline molecules, or their projection into the display plane will rotate. Due to the flexoelectric polarisation, the direction of rotation of the molecules then depends on the sign of the voltage.

Further, WO 2008/104533 A1 describes arrangements where the electrodes are arranged as in an IPS display and arrangements where an additional base electrode is disposed on the same substrate, as in a fringe-field switching (FFS) display.

Moreover, it discloses arrangements where in-plane electrodes or FFS electrodes are optionally disposed on the substrate with parallel orientation of the liquid-crystalline molecules or on the substrate with vertical orientation of the liquid-crystalline molecules. The former is described there as the embodiment for liquid-crystalline media with positive Δε, the latter as the embodiment for liquid-crystalline media with negative Δε. However, a “pure” flexoelectric switching cannot be achieved, since proportions of dielectrical switching cannot be avoided due to dielectric coupling of the applied electrical field with the utilized media exhibiting negative or positive values for the dielectrically anisotropy Δε, which results in contrast to a “pure” flexoelectric switching in slower switching times.

In order to utilize “pure” flexoelectric switching in a light modulation element the following requirements on a liquid-crystalline medium should be satisfied in order to guarantee a good performance of the resulting light modulation element:
suitable low values for the dielectric anisotropy (Δε)
suitable high values for ε∥ and ε⊥, respectively,
suitable values for the birefringence to increase the retardation for a given director deviation,
suitable rotational viscosities to optimize switching speed, and
suitable elastic constants.

At the same time, the following requirements on the light modulation element, as such, should be optimized with respect to
the uniform HAN alignment throughout the entire liquid-crystalline medium,
the strong anchoring energies of the liquid crystalline medium to the corresponding alignment layers,
the applied electrical field which should be as uniform as possible,
the electrode spacing, and
the cell thickness.

A general object of the present invention is to alleviate the above problems and to provide an alternative to the commonly known light modulation elements of the prior art, or preferably, to provide an improved light modulation element.

Further, another object of the invention is to provide a light modulation element having the capability of generating high contrast and wide viewing angle images and exhibiting a fast in-plane switching, more particularly to reduce the total switching time enabling a satisfactory display of moving images.

Other objects of the present invention are to decrease the driving voltage of the light modulation element, to increase the optical aperture ratio and to increase the transmittance. The improvements of these parameters are in particularly important for portable applications, such as cellular phones.

### SUMMARY OF THE INVENTION

In view of the numerous requirements and parameters summarized above, surprisingly, the inventors of the present invention have found that a medium comprising one or more dielectrically negative compounds and one or more dielectrically positive compounds, characterized in that the medium as a whole exhibits a dielectrically anisotropy (Δε) in the range from −0.25 to +0.25 determined at a frequency of 1 kHz and at 20° C. fulfils one or more, preferably all at the same time of the above described objects.

Further, the invention relates to a method of production of a medium exhibiting a dielectrically anisotropy (Δε) in the range from −0.25 to +0.25 characterized in that one or more dielectrically negative liquid crystalline compounds are mixed with one or more dielectrically positive liquid crystalline compounds.

Further, the invention relates to the use of the medium as described above and below in a light modulation element. Preferably, such light modulation element comprises a pair of substrates, an electrode structure, which is capable to allow the application of an electric field, which is substantially parallel to the substrate main plane, at least one planar alignment layer, at least one homeotropic alignment layer and a medium as described above and below.

The light modulation elements as described above and below are beneficially obtainable by commonly known methods of mass production.

Therefore, the invention relates to a method of production of a light modulation element as described above and below comprising the steps of
a. providing an electrode structure on at least one of the substrates,
b. providing at least one planar alignment layer on one of the substrates,
c. providing at least one homeotropic alignment layer on the other substrate,
d. providing a layer of a medium as described above and below on one of the substrates, and
assembling the cell.

The light modulation element as described above and below are particularly suitable for their utilization in electro-optical devices, since they exhibit especially, beside other beneficial properties, the following properties:
a favourable low-cost electrode-structure,
a favourable optical aperture,
a favourable low driving voltage,
a favourable low viewing angle dependence,
a favourable optical extinction and therefore a favourable contrast,
a favourable degree of self-compensation, and
favourable fast switching times.

Therefore, the invention relates to the use of a light modulation element as described above and below, in electro-optical devices and to electro-optical devices, such as an LCD, comprising at least one light modulation element as described above and below.

### Terms and Definition

The term “light modulation element” relates to devices capable of altering the phase or polarisation state of the light. Devices that are operated in refractive modes are excluded.

The term “liquid crystal (LC)” relates to materials having liquid-crystalline mesophases in some temperature ranges (thermotropic LCs) or in some concentration ranges in solutions (lyotropic LCs). They obligatorily contain mesogenic compounds.

The terms “mesogenic compound” or “liquid crystal compound” are taken to mean a compound comprising one or more uniaxial calamitic (rod-, brick-, or board/lath-shaped) or uniaxial discotic (disk-shaped) mesogenic group. The term “mesogenic group” means a group with the ability to induce liquid-crystalline phase (or mesophase) behaviour. The compounds comprising mesogenic groups do not necessarily have to exhibit a liquid-crystalline mesophase themselves. It is also possible that they show liquid-crystalline mesophases only in mixtures with other compounds.

A calamitic mesogenic group usually comprises a mesogenic core. The mesogenic core consists of one or more aromatic or non-aromatic cyclic groups, which are connected to each other directly or via linkage groups and optionally comprising terminal groups attached to the ends of the mesogenic core. Optionally, the mesogenic group comprises one or more groups that are laterally attached to the long side of the mesogenic core, wherein these terminal and lateral groups are usually selected e.g. from carbyl or hydrocarbyl groups, polar groups like halogen, nitro, hydroxy, etc.

For the purposes of the present invention, the term “liquid-crystalline medium” or “liquid crystal material” is taken to mean a material, which exhibits liquid-crystalline properties under certain conditions. In particular, the term is taken to mean a material, which forms a liquid-crystalline phase under certain conditions. A liquid-crystalline medium may comprise one or more liquid-crystalline compounds and in addition further substances.

The term “director” is known in prior art and means the preferred orientation direction of the long molecular axes (in case of calamitic compounds) or short molecular axes (in case of discotic compounds) of the liquid-crystalline molecules. In case of uniaxial ordering of such anisotropic molecules, the director is the axis of anisotropy.

The term “alignment” or “orientation” relates to alignment (orientation ordering) of anisotropic units of material such as small molecules or fragments of big molecules in a common direction named “alignment direction”. In an aligned layer of liquid-crystalline material, the liquid-crystalline director coincides with the alignment direction so that the alignment direction corresponds to the direction of the anisotropy axis of the material.

The term “planar orientation/alignment”, for example in a layer of a liquid-crystalline material, means that the long molecular axes (in case of calamitic compounds) or the short molecular axes (in case of discotic compounds) of a proportion of the liquid-crystalline molecules are oriented substantially parallel (about 180°) to the plane of the layer.

The term “homeotropic orientation/alignment”, for example in a layer of a liquid-crystalline material, means that the long molecular axes (in case of calamitic compounds) or the short molecular axes (in case of discotic compounds) of a proportion of the liquid-crystalline molecules are oriented at an angle θ (“tilt angle”) between about 80° to 90° relative to the plane of the layer.

The terms “uniform orientation” or “uniform alignment” of a liquid-crystalline material, for example in a layer of the material, mean that the long molecular axes (in case of calamitic compounds) or the short molecular axes (in case of discotic compounds) of the liquid-crystalline molecules are oriented substantially in the same direction. In other words, the lines of liquid-crystalline director are parallel.

The term “processed alignment layer” encompasses alignment layers which were either mechanically treated (rubbing) or exposed to light (preferably, photo-alignment by using polarized UV exposure) to introduce a preferred orientation direction for the liquid crystal molecules. After processing the originally physicochemical energy (e.g. surface energy) and/or the geometrical structure (e.g. grooves or directed side chains of polyimide material by rubbing) of the material is changed. For details on different treatments of alignment layers such as rubbing techniques, etc., c.f. T. Uchida and H. Seki, “Surface Alignment of Liquid Crystals,” Chapter 5 of Liquid Crystals: Applications and Uses, vol. 3, edited by B. Bahadur, World Scientific, 1995 or by Jacques Cognard, “Alignment of Nematic Liquid Crystals and their Mixtures”, Supplement 1, December 1982. Gordon and Breach Science Publishers, Inc., New York.

The term “unprocessed alignment layer” encompasses alignment layers, which were only coated and not further treated, whereby the original physicochemical energy (e.g. surface energy) and/or the geometrical structure of the material remain unchanged.

For the purposes of the present application, the term boundary state is taken to mean a state in which the transmission of light reaches a maximum or minimum value which depends on the applied electrical field.

Preferably, a light modulation element in accordance with the present invention has two boundary states, one, a boundary state A with a corresponding transmission T_{A} when no electrical field is applied the so-called “off” state, and the other, a boundary state B with a corresponding transmission T_{B} when an electrical field is applied the so-called “on” state, whereby:

T_{A}<T_{B}

For the purposes of the present application, the term light transmission is taken to mean the passage of electromagnetic radiation in the visible (VIS), near infrared (near-IR, NIR) and UV-A region through the light modulation element.

For the purposes of the present application, the term in-plane electric field is taken to mean employing a AC electrical field substantially parallel to the substrates, respectively the liquid crystal layer.

The optical retardation (δ(λ)) of a liquid-crystalline medium as a function of the wavelength of the incident beam (λ) is given by the following equation:

δ(λ)=(2πΔn·d)/λ

wherein (Δn) is the birefringence of the liquid-crystalline medium, (d) is the thickness of the layer of the liquid-crystalline medium and λ is the wavelength of light. The wavelength of light generally referred to in this application is 550 nm, unless explicitly specified otherwise.

The birefringence Δn herein is defined as,

Δn=nₑ−nₒ

wherein nₑ is the extraordinary refractive index and nₒ is the ordinary refractive index, and the effective average refractive index n_{av.} is given by,

n_{av.}=[(2nₒ²+nₑ²)/3]^{1/2}

The extraordinary refractive index nₑ and the ordinary refractive index no can be measured using an Abbe refractometer. The birefringence (Δn) can then be calculated.

The induced retardation can be written as

$$δ n = {n}_{o} ( 1 - \frac{{n}_{o}^{2}}{{n}_{e}^{2}} ) ( \frac{{e}_{3}^{2} {E}^{2} {d}^{3}}{24 {K}_{33}^{2}} )$$

wherein (nₑ) is the extraordinary refractive index, (nₒ) is the ordinary refractive index, (d) is the thickness of the layer of the liquid-crystalline medium, e₃ is the bend flexoelectric coefficient, K₃₃ is the bend elastic constant.

In the present application, the term “dielectrically positive” is used for compounds or components with Δε>3.0 and “dielectrically negative” with Δε<−1.5. A is determined at a frequency of 1 kHz and at 20° C. The dielectric anisotropy of the respective compound is determined from the results of a solution of 10% of the respective individual compound in a nematic host mixture. In case the solubility of the respective compound in the host medium is less than 10% its concentration is reduced by a factor of 2 until the resultant medium is stable enough at least to allow the determination of its properties. Preferably, the concentration is kept at least at 5%, however, in order to keep the significance of the results as high as possible. The capacitance of the test mixtures are determined both in a cell with homeotropic and with homogeneous alignment. The cell gap of both types of cells is approximately 20 μm. The voltage applied is a rectangular wave with a frequency of 1 kHz and a root mean square value typically of 0.5 V to 1.0 V; however, it is always selected to be below the capacitive threshold of the respective test mixture.

Δε is defined as (ε∥−ε⊥), whereas ε_{av.} is (ε∥+2 ε⊥)/3. The dielectric permittivity of the compounds is determined from the change of the respective values of a host medium upon addition of the compounds of interest. The values are extrapolated to a concentration of the compounds of interest of 100%. A typical host medium is ZLI-4792 or BL-087 both commercially available from Merck, Darmstadt.

All temperatures, such as, for example, the melting point T(C,N) or T(C,S), the transition from the smectic (S) to the nematic (N) phase T(S,N) and the clearing point T(N,I) of the liquid crystals, are quoted in degrees Celsius. All temperature differences are quoted in differential degrees.

The term “clearing point” means the temperature at which the transition between the mesophase with the highest temperature range and the isotropic phase occurs.

Throughout this application and unless explicitly stated otherwise, all concentrations are given in weight percent and relate to the respective complete medium. All physical properties have been and are determined according to “Merck Liquid Crystals, Physical Properties of Liquid Crystals”, Status November 1997, Merck KGaA, Germany and are given for a temperature of 20° C., unless explicitly stated otherwise.

In case of doubt the definitions as given in C. Tschierske, G. PelzI and S. Diele, Angew. Chem. 2004, 116, 6340-6368 shall apply.

The ranges of the parameters that are indicated in this application all include the limit values, unless expressly stated otherwise.

Throughout this application, the substituents on the saturated 1,4-substituted ring systems are, unless indicated otherwise, in the trans configuration. The other formulae stand for both configurations and preferably for the trans-configuration

The different upper and lower limit values indicated for various ranges of properties in combination with one another give rise to additional preferred ranges.

Throughout the description and claims of this specification, the words “comprise” and “contain” and variations of the words, for example “comprising” and “comprises”, mean “including but not limited to”, and are not intended to (and do not) exclude other components. On the other hand, the word “comprise” also encompasses the term “consisting of” but is not limited to it.

For the present invention,

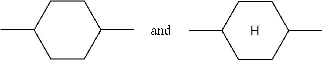

denote 1,4-cyclohexylene, and in particular

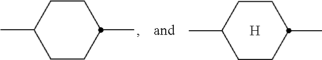

denote trans-1,4-cyclohexylene.

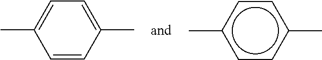

denote 1,4-phenylene.

### DETAILED DESCRIPTION

A suitable liquid-crystalline medium in accordance with the present invention comprises 2 or more, preferably at least 3, particularly preferably at least 4 and very particularly preferably at least 5, different liquid-crystalline compounds. If only 2 liquid-crystalline compounds are employed, their typical concentration ranges from about 70% to 99% by weight of the total mixture.

In the following conditions for the liquid-crystalline media according to preferred embodiments of the present invention are given. These preferred conditions may be fulfilled individually or, preferably in combinations with each other. Binary combinations thereof are preferred, whereas ternary or higher combinations thereof are particularly preferred.

In accordance with the invention, the liquid-crystalline medium preferably exhibits neutral values for the dielectric anisotropy Δε. In this case, Δε preferably has a value of in the range from approximately ≥−0.25 to approximately ≤+0.25, more preferably from approximately ≥−0.10 to approximately ≤+0.10, even more preferably from approximately ≥−0.05 to approximately ≤+0.05 determinedat a frequency of 1 kHz and at 20° C.

In accordance with the invention, the liquid-crystalline medium preferably exhibits high values for ε∥, while at the same time, the liquid-crystalline medium preferably exhibits high values for ε⊥.

Preferably, ≥∥ and ε⊥ each and independently from another have a value of in the range from approximately ≥1 to approximately ≤20, more preferably from approximately ≥2 to approximately ≤15, even more preferably from approximately ≥3 to approximately ≤10.

The liquid-crystal media in accordance with the present invention preferably have a clearing point of approximately 65° C. or more, more preferably approximately 70° C. or more, still more preferably 80° C. or more, particularly preferably approximately 85° C. or more and very particularly preferably approximately 90° C. or more.

The nematic phase of the media according to the invention preferably extends at least from approximately 0° C. or less to approximately 65° C. or more, more preferably at least from approximately 20° C. or less to approximately 70° C. or more, very preferably at least from approximately 30° C. or less to approximately 70° C. or more and in particular at least from approximately 40° C. or less to approximately 90° C. or more. In individual preferred embodiments, it may be necessary for the nematic phase of the media according to the invention to extend to a temperature of approximately 100° C. or more and even to approximately 110° C. or more.

The Δn of a suitable liquid-crystal media is preferably as high as possible. Typically, the Δn of the liquid-crystal media in accordance with the present invention, at 589 nm (NaD) and 20° C., is preferably in the range from approximately 0.08 or more to approximately 0.35 or more, more preferably in the range from approximately 0.10 or more to approximately 0.30 or more, even more preferably in the range from approximately 0.12 or more to approximately 0.25 or more.

The liquid-crystal media used in the light modulation element according to the present invention preferably have an elastic constant K₁₁ of approximately 10 pN or more, more preferably of approximately 12 pN or more, and even more preferably of approximately 15 pN or more.

The liquid-crystal media used in the light modulation element according to the present invention preferably have an elastic constant K₃₃ of approximately 35 pN or less, more preferably of approximately 30 pN or less, and even more preferably of approximately 25 pN or less.

The rotational viscosity of a suitable liquid-crystal media is preferably as low as possible. Typically, the media according to the present invention, exhibit a rotational viscosity of approximately 300 mPas or less, preferably of approximately 200 mPas or less.

In a preferred embodiment, the medium in accordance with the present invention comprises one or more dielectrically negative compounds selected from the group of the compounds of the formulae IA, IB and IC,

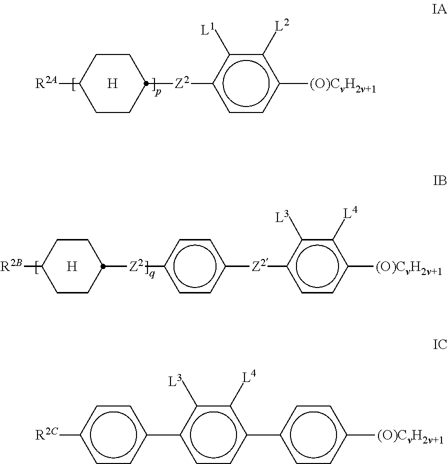

in which
R^{2A}, R^{2B} and R^{2C} each, independently of one another, denote H, an alkyl or alkenyl radical having up to 15 C atoms which is unsubstituted, monosubstituted by CN or CF₃ or at least monosubstituted by halogen, where, in addition, one or more CH₂ groups in these radicals may be replaced by —O—, —S—,

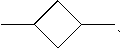

—C≡C—, —CF₂O—, —OCF₂—, —OC—O— or —O—CO— in such a way that O atoms are not linked directly to one another,
L¹⁻⁴ each, independently of one another, denote F, Cl, CF₃ or CHF₂,
Z² and Z^{2′} each, independently of one another, denote a single bond, —CH₂CH₂—, —CH═CH—, —CF₂O—, —OCF₂—, —CH₂O—, —OCH₂—, —COO—, —OCO—, —C₂F₄—, —CF═CF—, —CH═CHCH₂O—,
p denotes 0, 1 or 2,
q denotes 0 or 1, and
v denotes 1 to 6.

In the compounds of the formulae IA and IB, Z² may have identical or different meanings. In the compounds of the formula IB, Z² and Z^{2′} may have identical or different meanings.

In the compounds of the formulae IA, IB and IC, R^{2A}, R^{2B} and R^{2C} each preferably denote alkyl having 1-6 C atoms, in particular CH₃, C₂H₅, n-C₃H₇, n-C₄H₉, n-C₅H₁₁.

In the compounds of the formulae IA and IB, L¹, L², L³ and L⁴ preferably denote L¹=L²=F and L³=L⁴=F, furthermore L¹=F and L²=Cl, L¹=Cl and L²=F, L³=F and L⁴=Cl, L³=Cl and L⁴=F. Z² and Z^{2′} in the formulae IA and IB preferably each, independently of one another, denote a single bond, furthermore a —C₂H₄— bridge.

If, in the formula IB, Z²═—C₂H₄— or —CH₂O—, Z^{2′} is preferably a single bond or, if Z^{2′}═—C₂H₄— or —CH₂O—, Z² is preferably a single bond. In the compounds of the formulae IA and IB, (O)CᵥH₂ᵥ₊₁ preferably denotes OCᵥH₂ᵥ₊₁, furthermore CᵥH₂ᵥ₊₁. In the compounds of the formula IC, (O)CᵥH₂ᵥ₊₁ preferably denotes CᵥH₂ᵥ₊₁. In the compounds of the formula IC, L³ and L⁴ preferably each denote F.

Preferred compounds of the formulae IA, IB and IC are indicated below:

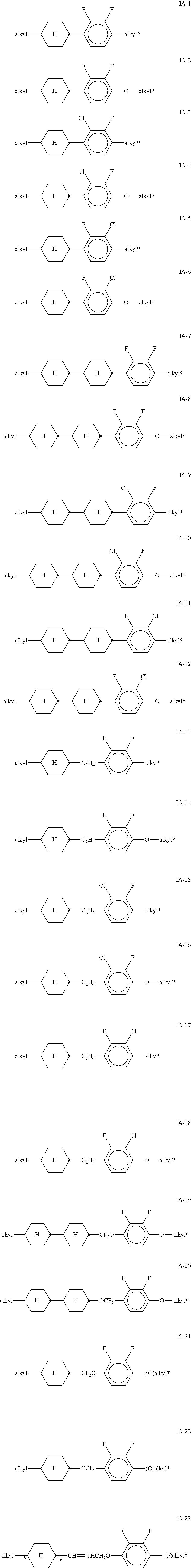

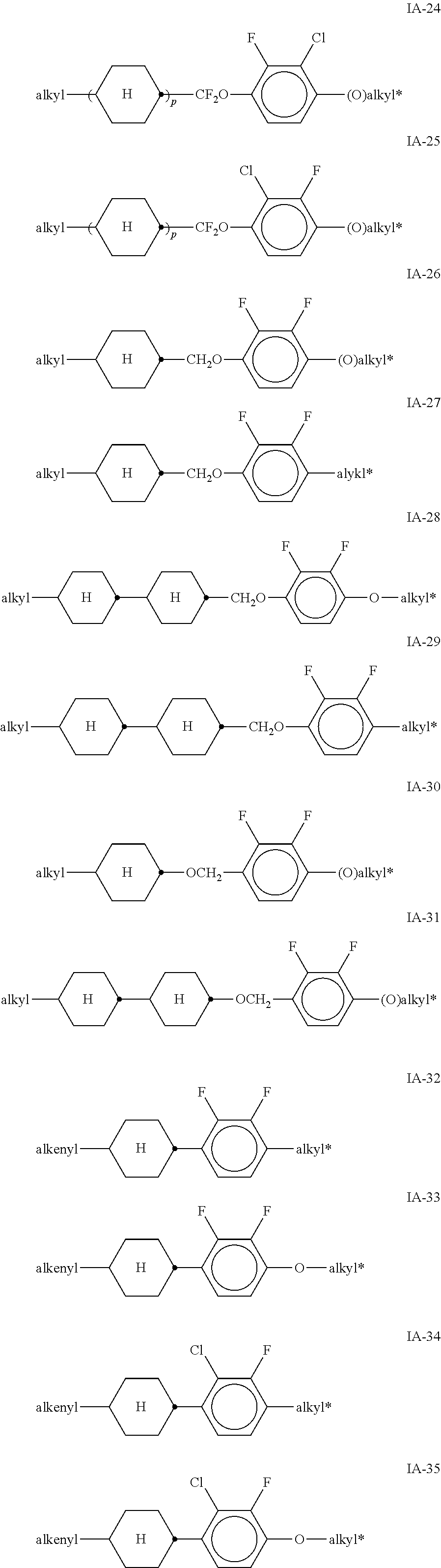

[chemical structure]

in which alkyl and alkyl* each, independently of one another, denote a straight-chain alkyl radical having 1-6 C atoms.

Particularly preferred mixtures according to the invention comprise one or more compounds of the formulae IA-2, IA-8, IA-14, IA-26, I-28, IA-33, IA-39, IA-45, IA-46, IA-47, IA-50, IB-2, IB-11, IB-16 and IC-1.

If present, the proportion of compounds of the formulae IA and/or IB and/or IC or their subformulae in the mixture as a whole is preferably at least 10% by weight, more preferably at least 12% by weight, especially at least 15% by weight.

If present, the proportion of compounds of the formulae IA and/or IB and/or IC or their subformulae in the mixture as a whole is preferably at most 50% by weight, more preferably at most 45% by weight, especially at most 40% by weight.

Further preferred liquid-crystalline media comprise one or more dielectrically negative tetracyclic compounds of the formulae

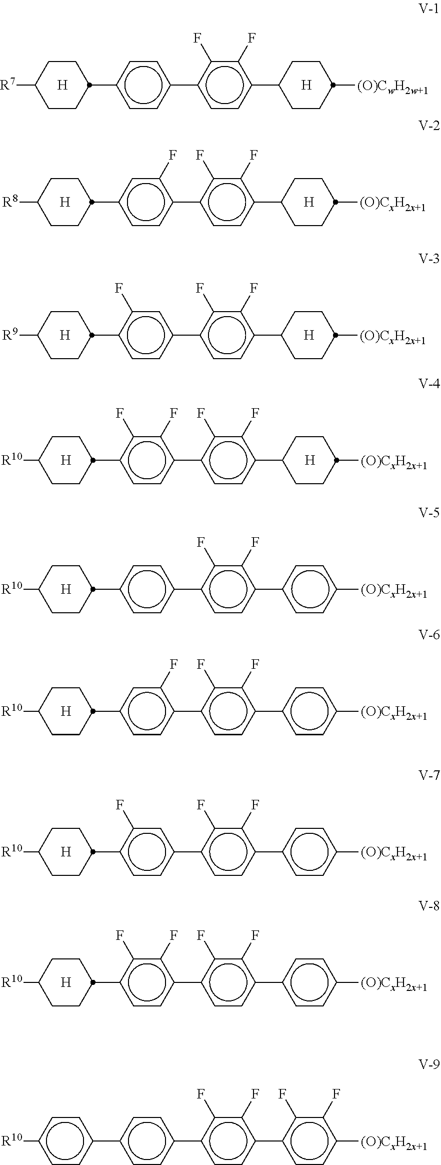

in which
R⁷⁻¹⁰ each, independently of one another, have one of the meanings indicated for R^{2A} as given above, and
w and x each, independently of one another, denote 1 to 6.

Particular preference is given to mixtures comprising at least one compound of the formula V-9.

Further preferred is a liquid-crystalline medium which comprises one or more dielectrically negative compounds of the formulae Y-1 to Y-6,

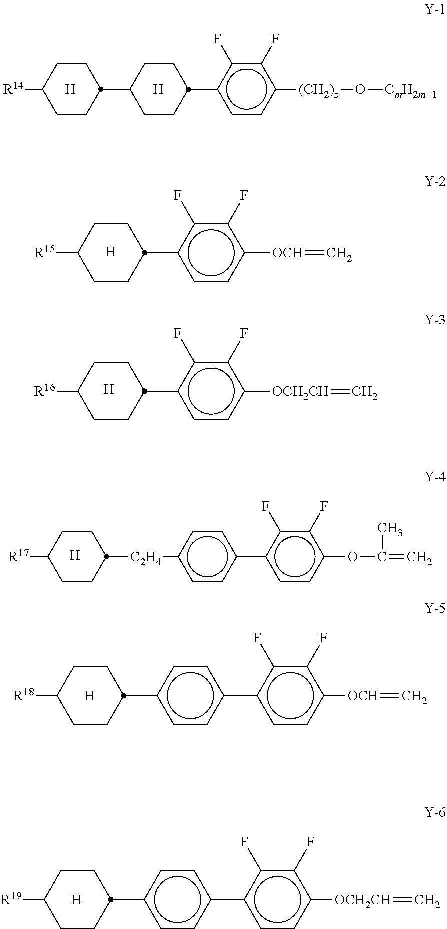

in which R¹⁴-R¹⁹ each, independently of one another, denote an alkyl or alkoxy radical having 1-6 C atoms; z and m each, independently of one another, denote 1-6; x denotes 0, 1, 2 or 3.

If present, the medium according to the invention particularly preferably comprises one or more compounds of the formulae Y-1 to Y-6, preferably in amounts of ≥2.5% by weight.

Further preferred is a liquid-crystalline medium which comprises one or more dielectrically negative fluorinated terphenyls of the formulae T-1 to T-19,

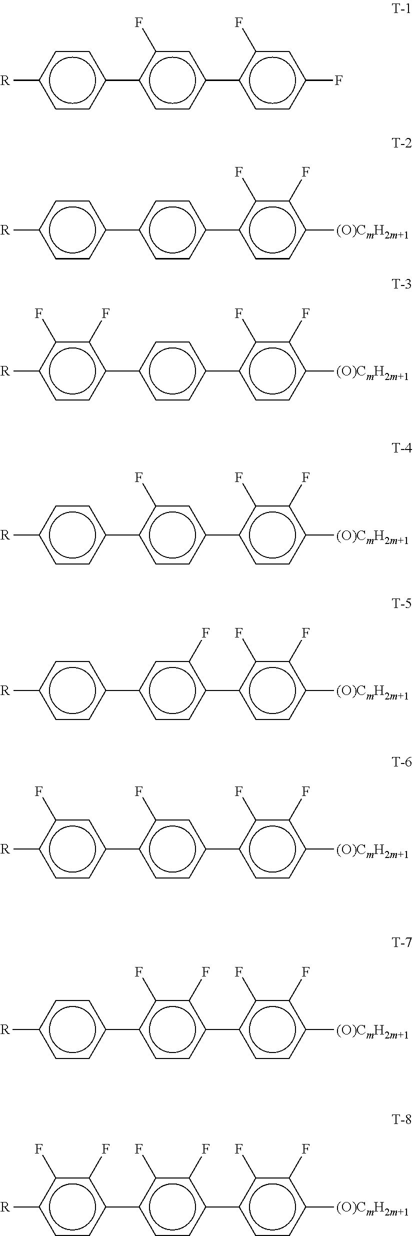

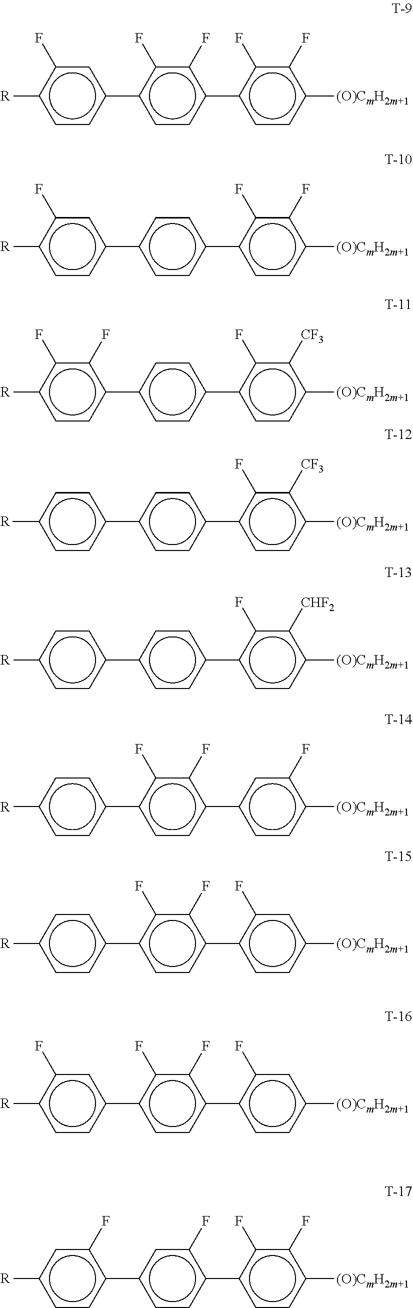

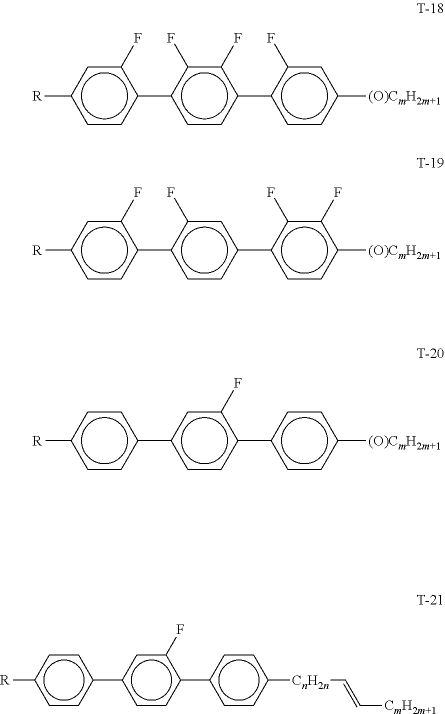

in which
R denotes a straight-chain alkyl or alkoxy radical having 1-7 C atoms, and m=0, 1, 2, 3, 4, 5 or 6 and n denotes 0, 1, 2, 3 or 4.

R preferably denotes methyl, ethyl, propyl, butyl, pentyl, hexyl, methoxy, ethoxy, propoxy, butoxy, pentoxy.

If present, the medium according to the invention preferably comprises the terphenyls of the formulae T-1 to T-19 in amounts of 2-30% by weight, in particular 5-10% by weight.

Particular preference is given to compounds of the formulae T-1, T-2, and T-4. In these compounds, R preferably denotes alkyl, furthermore alkoxy, each having 1-5 C atoms.

The terphenyls are preferably employed in the mixtures according to the invention if the Δn value of the mixture is to be ≥0.1. Preferred mixtures comprise 1-10% by weight of one or more terphenyl compounds selected from the group of the compounds T-1 to T-19.

Further preferred is a liquid-crystalline medium which comprises one or more dielectrically negative compounds of the formulae Z-1 to Z-7,

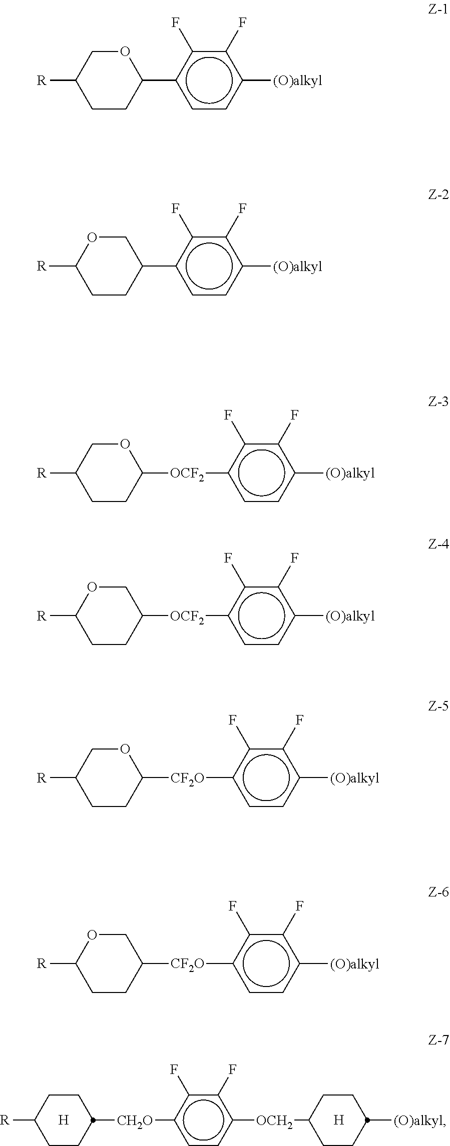

in which R and alkyl have the meanings indicated above.

Preferred liquid-crystalline media according to the invention comprise one or more dielectrically negative substances which contain a tetrahydronaphthyl or naphthyl unit, such as, for example, the compounds of the formulae N-1 to N-5,

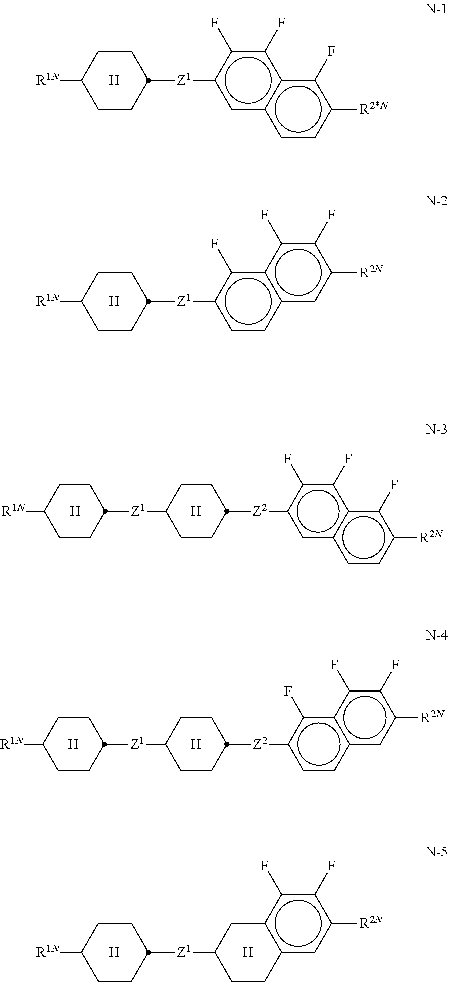

in which R^{1N} and R^{2N} each, independently of one another, have the meanings indicated for R^{2A}, preferably denote straight-chain alkyl, straight-chain alkoxy or straight-chain alkenyl, and
Z¹ and Z² each, independently of one another, denote —C₂H₄—, —CH═CH—, —(CH₂)₄—, —(CH₂)₃O—, —O(CH₂)₃—, —CH═CH CH₂CH₂—, —CH₂CH₂CH═CH—, —CH₂O—, —OCH₂—, —COO—, —OC O—, —C₂F₄—, —CF═CF—, —CF═CH—, —CH═CF—, —CF₂O—, —OCF₂—, —CH₂— or a single bond.

Preferred mixtures comprise one or more compounds selected from the group of the dielectrically negative difluorodibenzochroman compounds of the formula BC, chromans of the formula CR, fluorinated phenanthrenes of the formulae PH-1 and PH-2, fluorinated dibenzofurans of the formula BF-1 and BF-2,

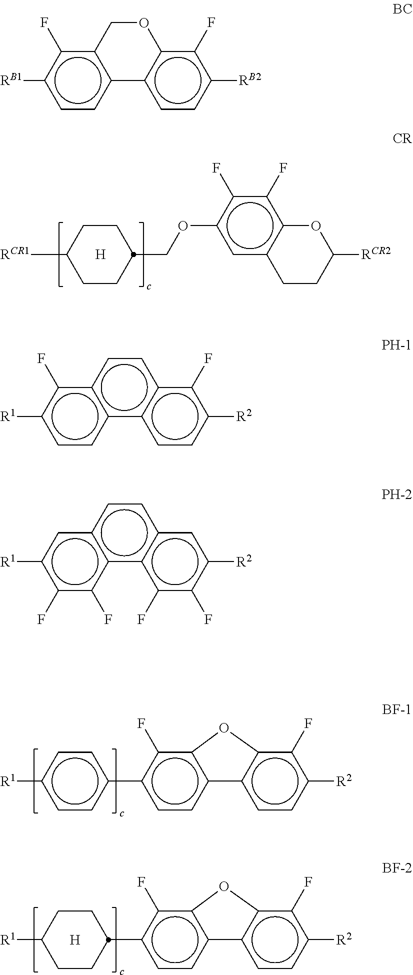

in which
R^{B1}, R^{B2}, R^{CR1}, R^{CR2}, R¹, R² each, independently of one another, have the meaning of R^{2A}. C is 0, 1 or 2. R¹ and R² preferably, independently of one another, denote alkyl or alkoxy having 1 to 6 C atoms.

If present, the mixtures according to the invention preferably comprise the compounds of the formulae BC, CR, PH-1, PH-2 and/or BF in amounts of 1 to 10% by weight, in particular in amounts of 2 to 8% by weight.

Particularly preferred compounds of the formulae BC and CR are the compounds BC-1 to BC-7 and CR-1 to CR-5,

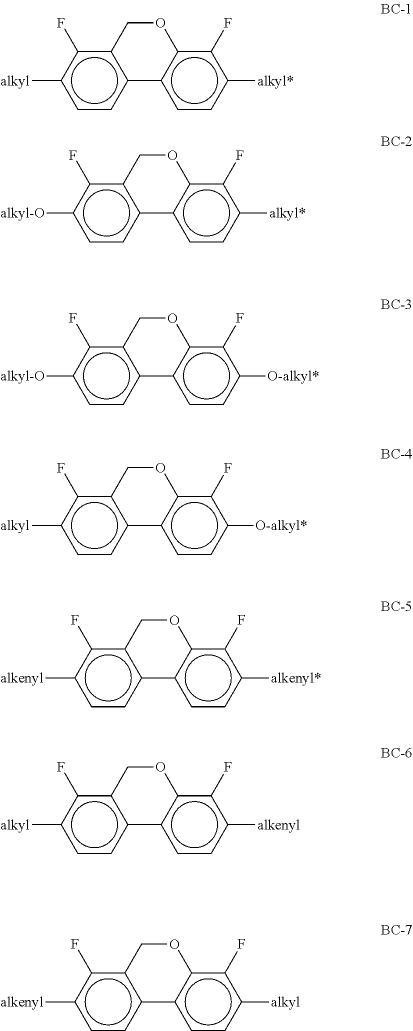

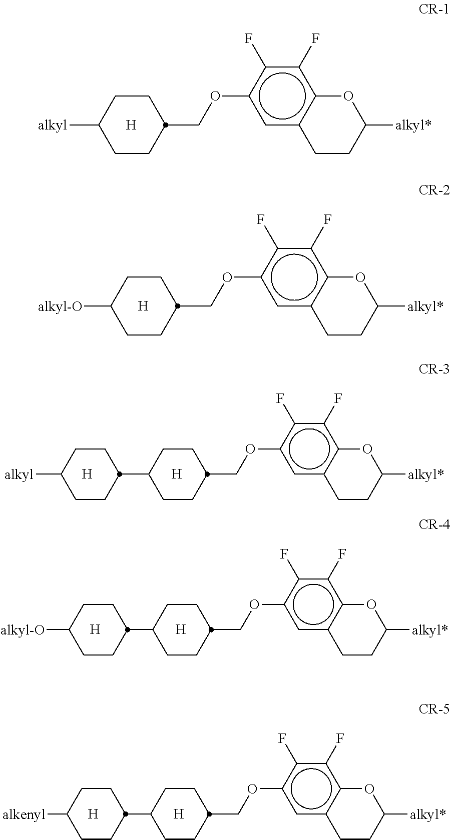

in which
alkyl and alkyl* each, independently of one another, denote a straight-chain alkyl radical having 1-6 C atoms, and
alkenyl and alkenyl* each, independently of one another, denote a straight-chain alkenyl radical having 2-6 C atoms.

Very particular preference is given to mixtures comprising one, two or three compounds of the formula BC-2, BF-1 and/or BF-2.

Preferred mixtures comprise one or more dielectrically negative indane compounds of the formula In,

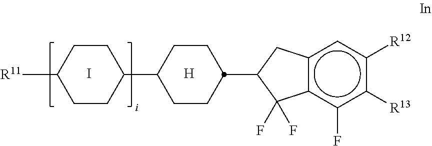

in which
R¹¹, R¹², R¹³ each, independently of one another, denote a straight-chain alkyl, alkoxy, alkoxyalkyl or alkenyl radical having 1-6 C atoms,
R¹² and R¹³ additionally denote halogen, preferably F,

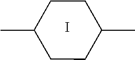

denotes

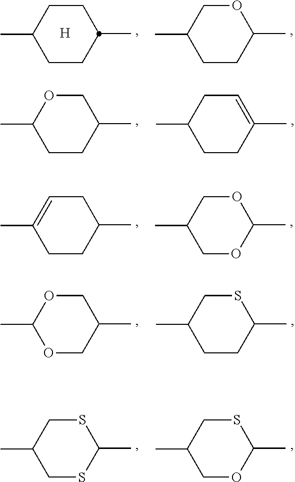

i denotes 0, 1 or 2.

Preferred compounds of the formula In are the compounds of the formulae In-1 to In-16 indicated below:

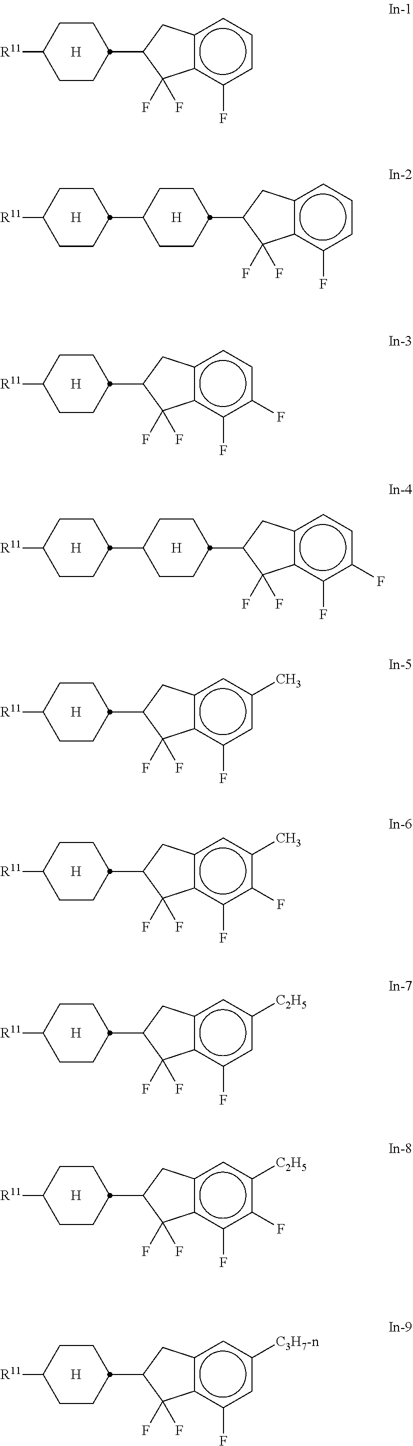

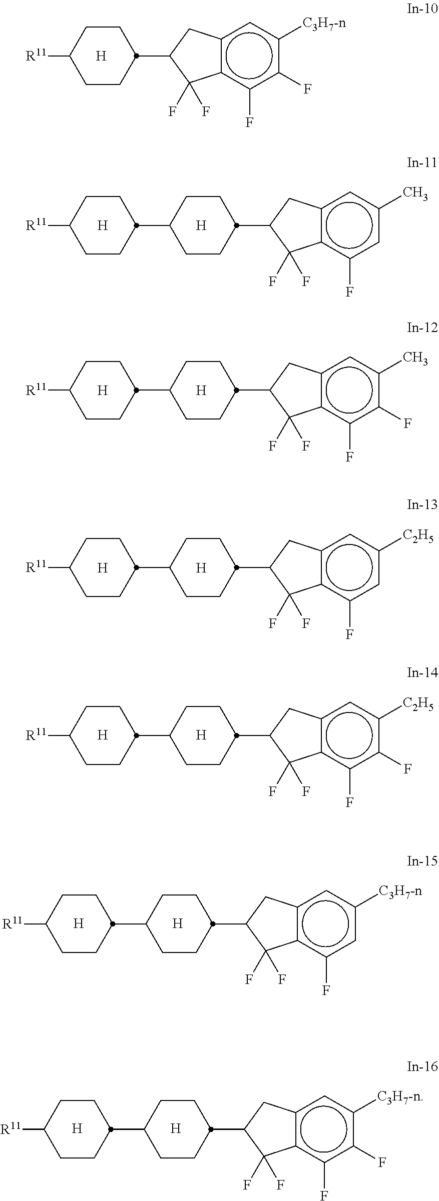

Particular preference is given to the compounds of the formulae In-1, In-2, In-3 and In-4.

If present, the compounds of the formula In and the sub-formulae In-1 to In-16 are preferably employed in the mixtures according to the invention in concentrations ≥2% by weight, in particular 3-15% by weight and very particularly preferably 5-10% by weight.

Further preferred is a liquid-crystalline medium which comprises one or more dielectrically negative compounds of the formulae L-1 to L-11,

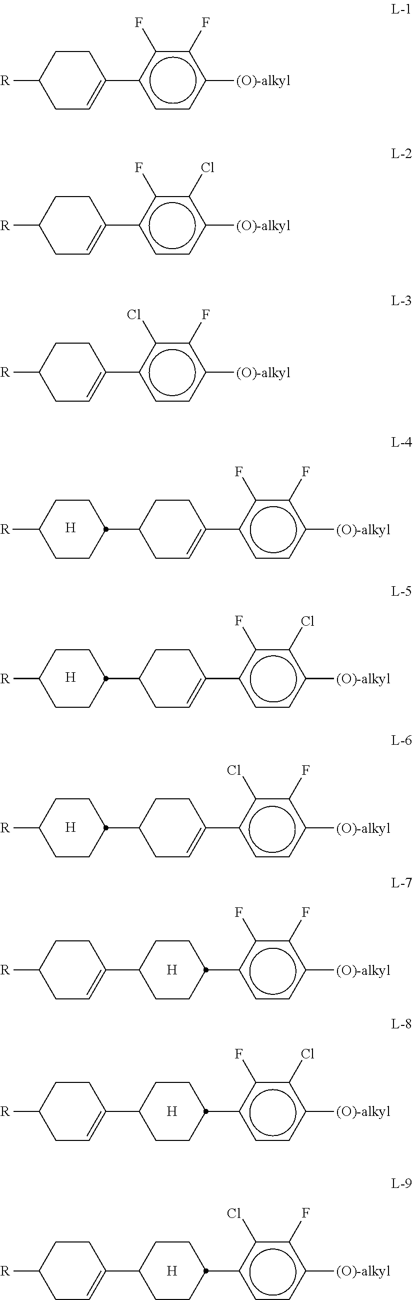

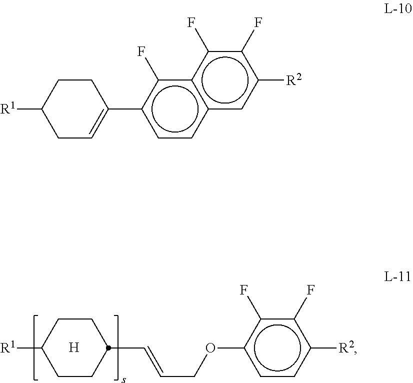

in which
R, R¹ and R² each, independently of one another, have the meanings indicated for R^{2A} in claim 5, and alkyl denotes an alkyl radical having 1-6 C atoms. s denotes 1 or 2.

Particular preference is given to the compounds of the formulae L-1 and L-4, in particular L-4.

If present, the compounds of the formulae L-1 to L-11 are preferably employed in concentrations of 2-25% by weight, in particular 2-20% by weight and very particularly preferably 5-15% by weight.

In a preferred embodiment, the liquid-crystalline medium comprises one or more dielectrically positive compounds, which are selected from the group of compounds of formulae II and III,

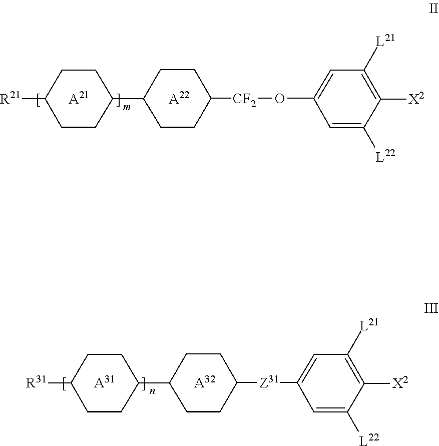

in which
R²¹ denotes alkyl, alkoxy, fluorinated alkyl or fluorinated alkoxy having 1 to 7 C atoms, alkenyl, alkenyloxy, alkoxyalkyl or fluorinated alkenyl having 2 to 7 C atoms and preferably alkyl or alkenyl,

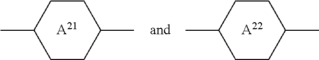

on each appearance, independently of one another, denote

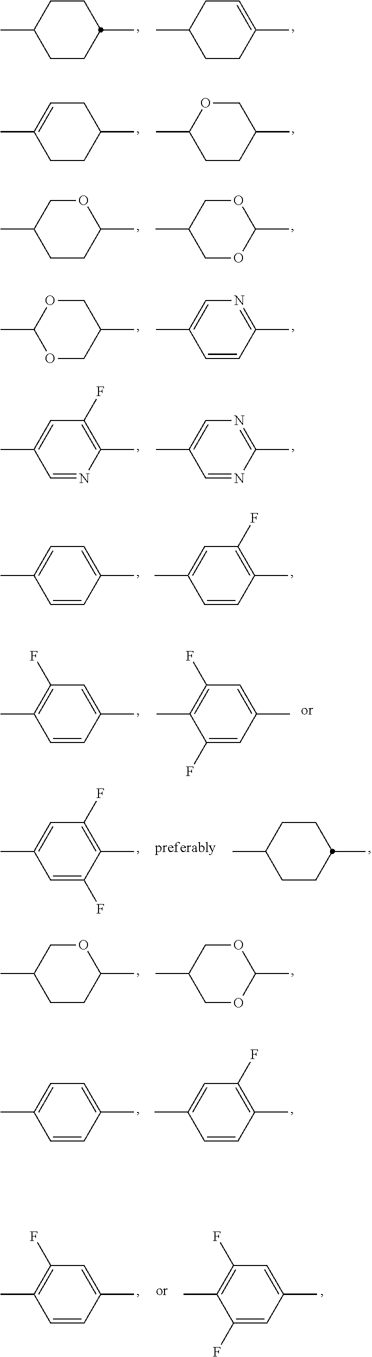

L²¹ and L²² denote H or F, preferably L²¹ denotes F,
X²¹ denotes halogen, halogenated alkyl or alkoxy having 1 to 3 C atoms or halogenated alkenyl or alkenyloxy having 2 or 3 C atoms, preferably F, Cl, —OCF₃, —O—CH₂CF₃, —O—CH═CH₂, —O—CH═CF₂ or —CF₃, very preferably F, Cl, —O—CH═CF₂ or —OCF₃,
m denotes 0, 1, 2 or 3, preferably 1 or 2 and particularly preferably 1,
R³¹ denotes alkyl, alkoxy, fluorinated alkyl or fluorinated alkoxy having 1 to 7 C atoms, alkenyl, alkenyloxy, alkoxyalkyl or fluorinated alkenyl having 2 to 7 C atoms and preferably alkyl or alkenyl,

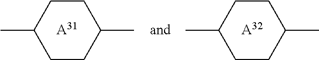

on each appearance, independently of one another, are

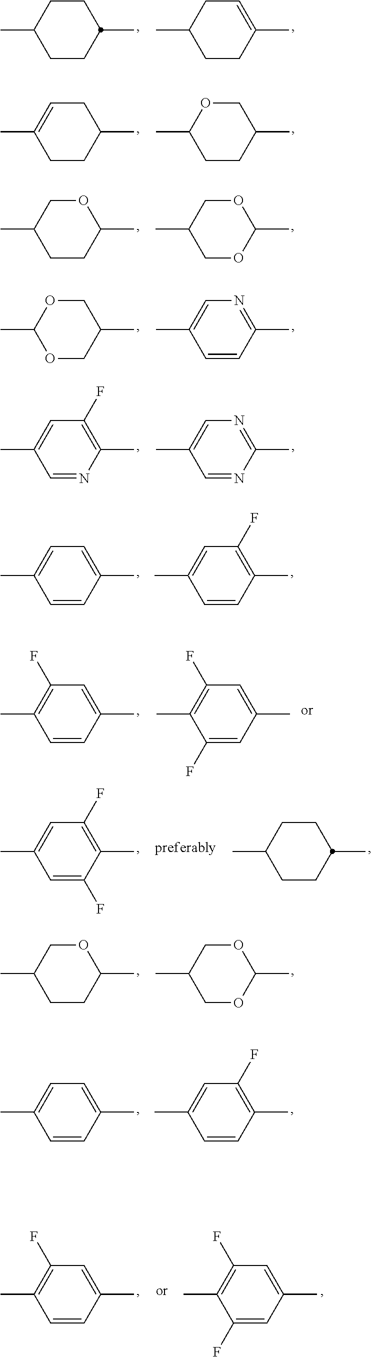

L³¹ and L³², independently of one another, denote H or F, preferably L³¹ denotes F,
X³¹ denotes halogen, halogenated alkyl or alkoxy having 1 to 3 C atoms or halogenated alkenyl or alkenyloxy having 2 or 3 C atoms, F, Cl, —OCF₃, —O—CH₂CF₃, —O—CH═CF₂, —O—CH═CH₂ or —CF₃, very preferably F, Cl, —O—CH═CF₂ or —OCF₃,
Z³¹ denotes —CH₂CH₂—, —CF₂CF₂—, —COO—, trans-CH═CH—, trans-CF═CF—, —CH₂O— or a single bond, preferably —CH₂CH₂—, —COO—, trans-CH═CH— or a single bond and very preferably —COO—, trans-CH═CH— or a single bond, and
n denotes 0, 1, 2 or 3, preferably 1 or 3 and particularly preferably 1.

Preferred compounds of formula II are selected from the group of compounds of subformulae II-1 and II-2:

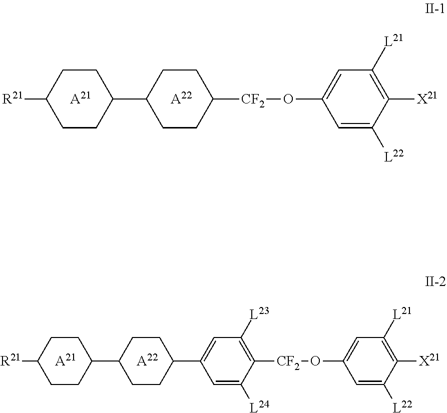

in which the parameters have the respective meanings indicated above under formula II, and L²³ and L²⁴, independently of one another, denote H or F, preferably L²³ denotes F, and ring A²¹ and ring A²² have one of the meanings given above
and, in the case of formulae II-1 and II-2, X²¹ preferably denotes F or OCF₃, particularly preferably F, and, in the case of formula II-2,

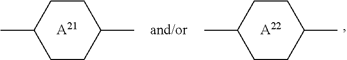

independently of one another, preferably denote

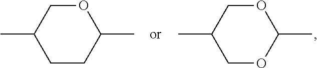

Preferred compounds of formula III are preferably selected from the group of compounds of formulae III-1 and III-2:

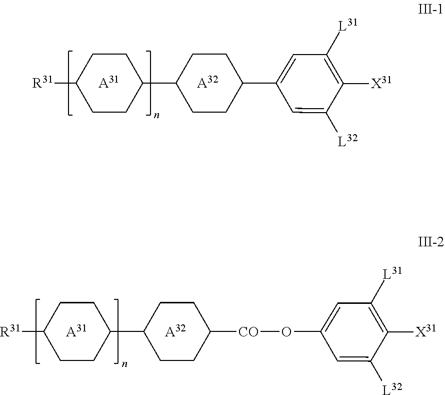

in which the parameters have the meanings given under formula III.

The media in accordance with the present invention preferably comprise, alternatively or in addition to the compounds of the formulae III-1 and/or III-2, one or more compounds of the formula III-3

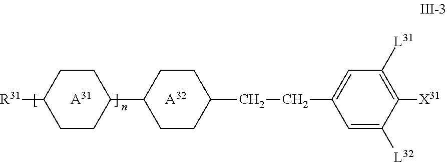

in which the parameters have the respective meanings indicated above, and the parameters L³³ and L³⁴, independently of one another and of the other parameters, denote H or F.

The liquid-crystal medium preferably comprises compounds selected from the group of the compounds of the formulae II-1 to II-4 in which L²¹ and L²² and/or L²³ and L²⁴ both denote F.

In a preferred embodiment, the liquid-crystal medium comprises compounds selected from the group of the compounds of the formulae II-2 and II-3 in which L²¹, L²², L²³ and L²⁴ all denote F.

The liquid-crystal medium preferably comprises one or more compounds of the formula II-1. The compounds of the formula II-1 are preferably selected from the group of the compounds of the formulae II-1a to II-1e, preferably of formula II-1d:

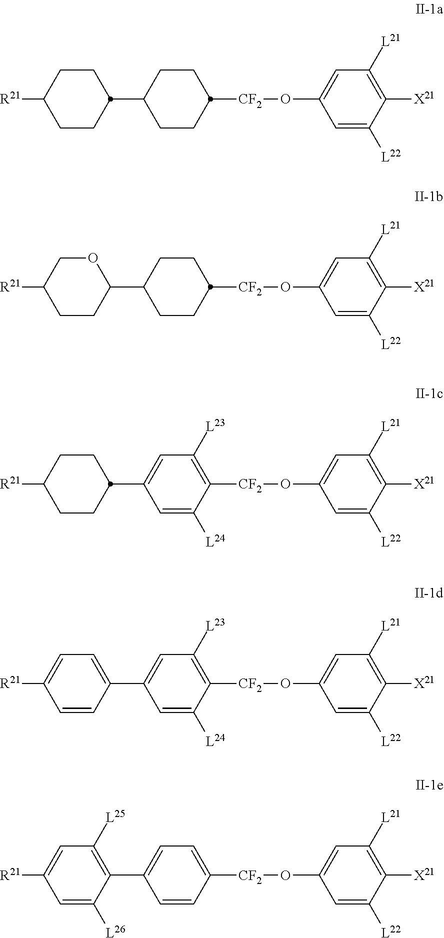

in which the parameters have the respective meanings indicated above, and L²⁵ and L²⁶, independently of one another and of the other parameters, denote H or F, and preferably in the formulae II-1a and II-1 b, L²¹ and L²² both denote F, in the formulae II-1c and II-1d, L²¹ and L²² both denote F and/or L²³ and L²⁴ both denote F, and in formula II-1e, L²¹, L²² and L²⁵ denote F.

The liquid-crystal medium preferably comprises compounds selected from the group of the compounds of the formulae II-1a to II-1e in which L²¹ and L²² both denote F and/or L²³ and L²⁴ both denote F.

In a preferred embodiment, the liquid-crystal medium comprises compounds selected from the group of the compounds of the formulae II-1a to II-1d in which L²¹, L²², L²³ and L²⁴ all denote F.

The liquid-crystal medium preferably comprises one or more compounds of the formula II-2, which are preferably selected from the group of the compounds of the formulae II-2a to II-2j, preferably of formula II-2j:

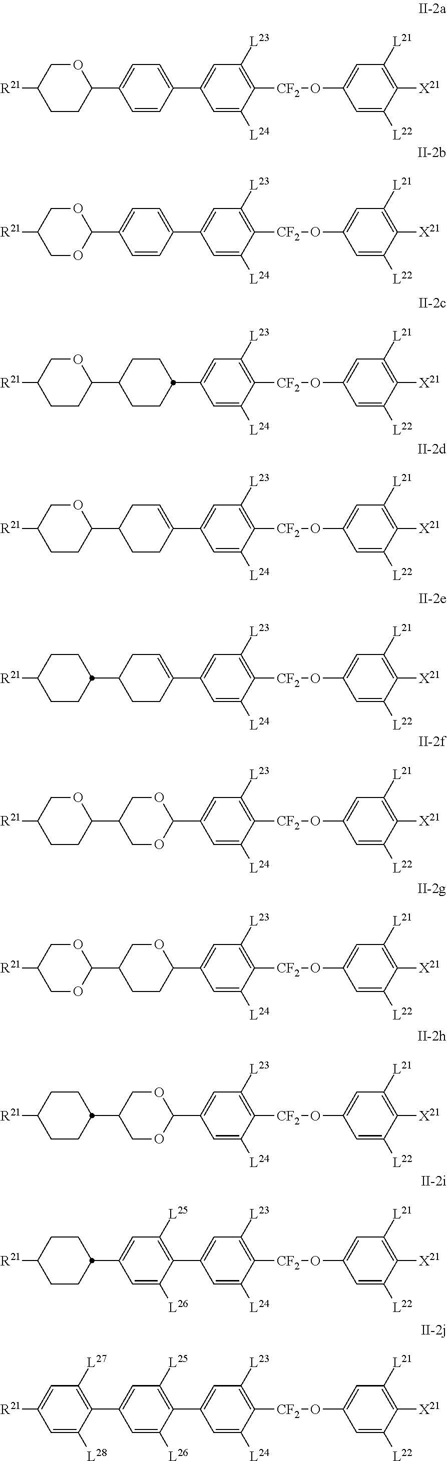

in which the parameters have the respective meanings indicated above, and L²⁵ to L²⁸, independently of one another, denote H or F, preferably L²⁷ and L²⁸ both denote H, particularly preferably L²⁶ denotes H.

Especially preferred compounds of the formula II-2 are the compounds of the following formulae:

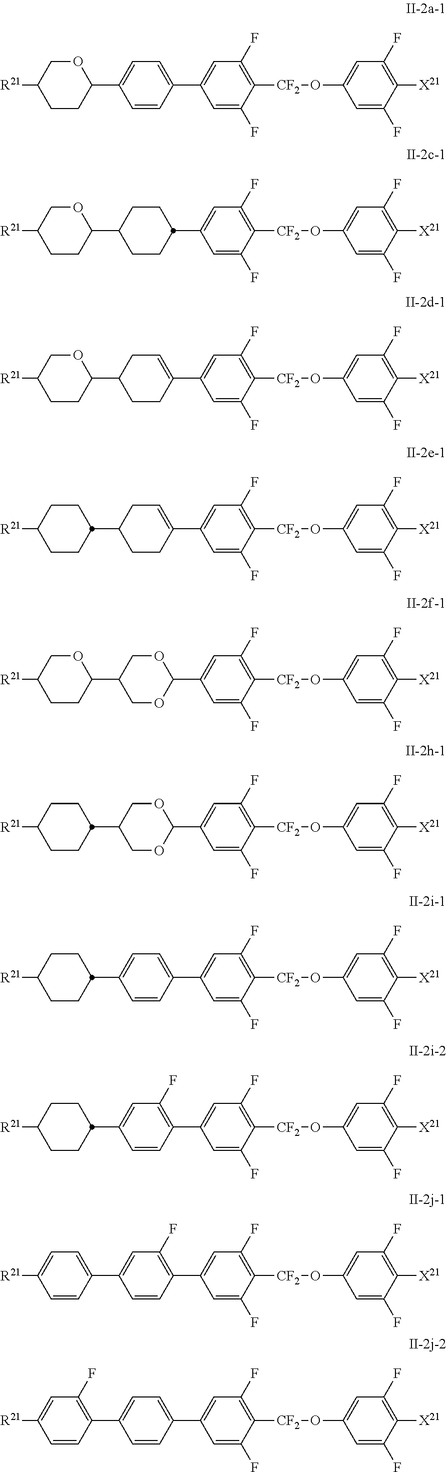

in which R²¹ and X²¹ have the meanings indicated above, and X²¹ preferably denotes F.

The liquid-crystal medium preferably comprises one or more compounds of the formula III-1. Suitable compounds of the formula III-1 are preferably selected from the group of the compounds of the formulae III-1a to III-1j, preferably from formulae III-1c, III-1f, III-1g and III-1j:

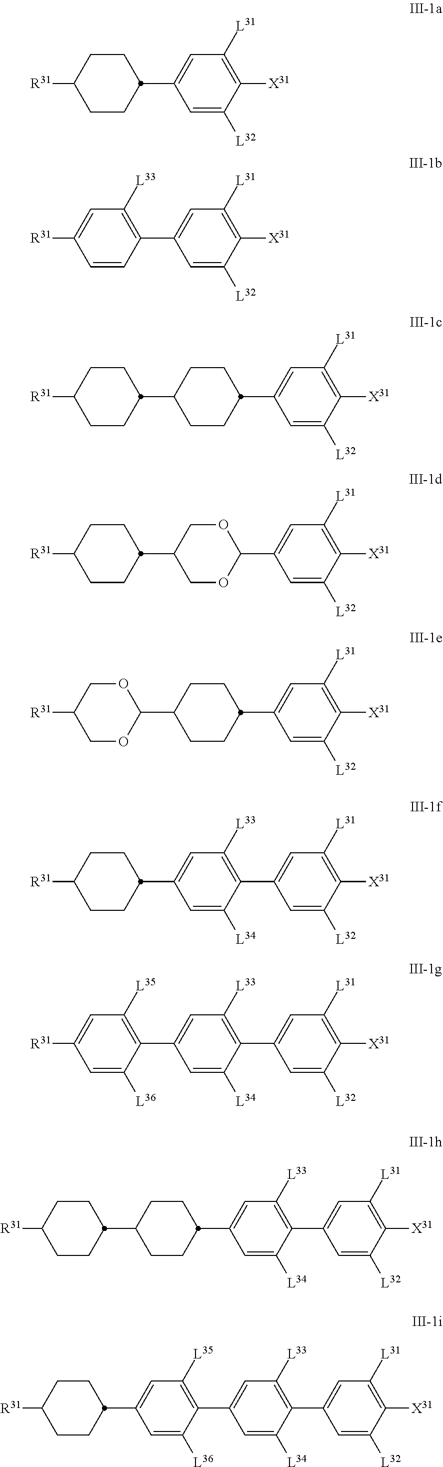

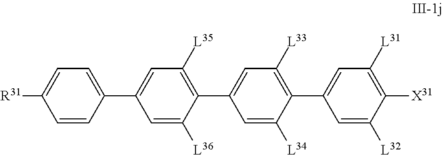

in which the parameters have the meanings given above and preferably in which the parameters have the respective meanings indicated above, and the parameters L³⁵ and L³⁶, independently of one another and of the other parameters, denote H or F.

The liquid-crystal medium preferably comprises one or more compounds of the formula III-1c, which are preferably selected from the group of the compounds of the formulae III-1c-1 to III-1c-5, preferably of formulae III-1c-3 and III-1c-4:

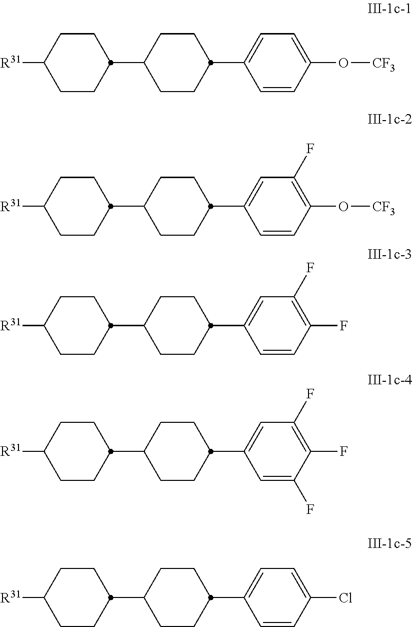

in which R³¹ has the meaning indicated above.

The liquid-crystal medium preferably comprises one or more compounds of the formula III-1f, which are preferably selected from the group of the compounds of the formulae III-1f-1 to III-1f-5, preferably of formulae III-1f-1, III-1f-2, III-1f-4 and III-1f-5, more preferably of formulae III-1f-1, III-1f-4 and III-1f-5, more preferably:

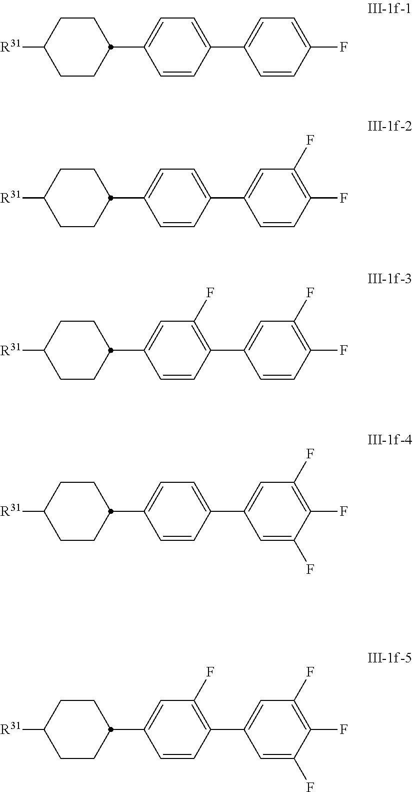

in which R³¹ has the meaning indicated above.

The liquid-crystal medium preferably comprises one or more compounds of the formula III-1g, which are preferably selected from the group of the compounds of the formulae III-1g-1 to III-1g-5, preferably of formula III-1g-3:

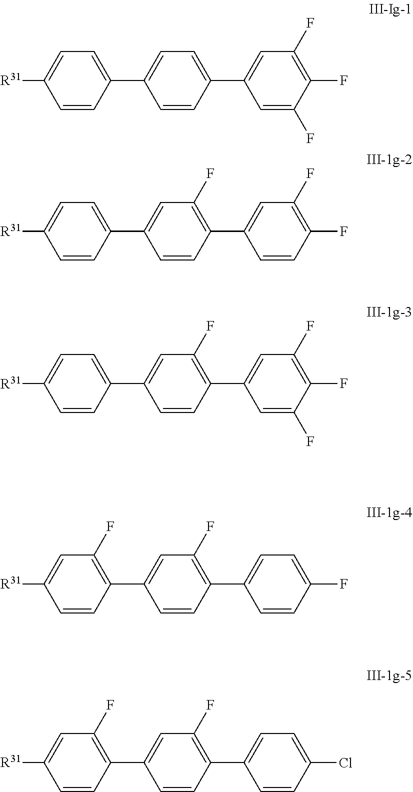

in which R³¹ has the meaning indicated above.

The liquid-crystal medium preferably comprises one or more compounds of the formula III-1 h, which are preferably selected from the group of the compounds of the formulae III-1 h-1 to III-1 h-3, preferably of the formula III-1 h-3:

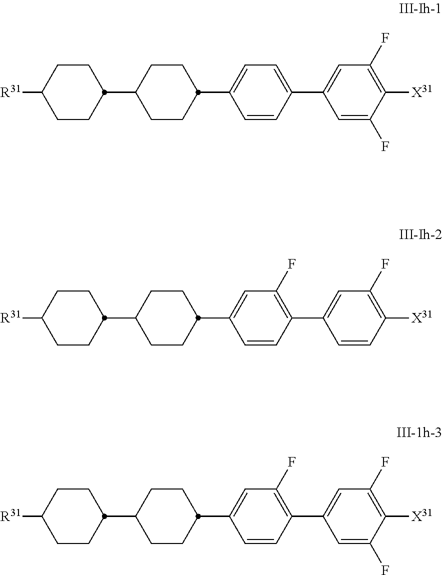

in which the parameters have the meanings given above, and X³¹ preferably denotes F.

The liquid-crystal medium preferably comprises one or more compounds of the formula III-1i, which are preferably selected from the group of the compounds of the formulae III-1 i-1 and III-1i-2, preferably of the formula III-1i-2:

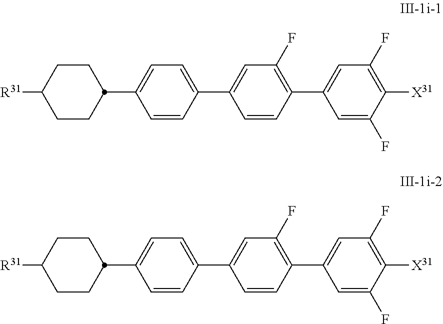

in which the parameters have the meanings given above, and X³¹ preferably denotes F.

The liquid-crystal medium preferably comprises one or more compounds of the formula III-1j, which are preferably selected from the group of the compounds of the formulae III-1j-1 and III-1j-2, preferably of the formula III-1j-1:

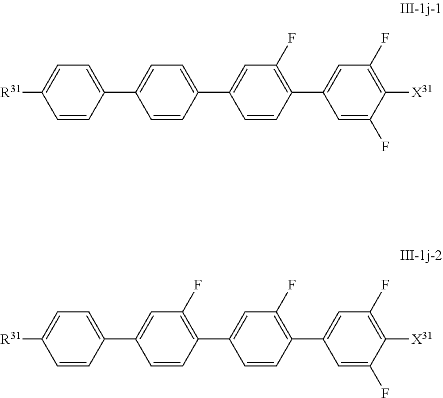

in which the parameters have the meanings given above.

The liquid-crystal medium preferably comprises one or more compounds of the formula III-2. The compounds of the formula III-2 are preferably selected from the group of the compounds of the formulae III-2a and III-2b:

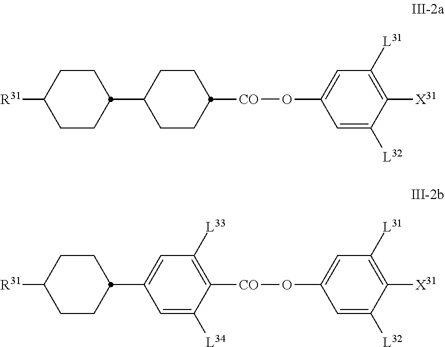

in which the parameters have the respective meanings indicated above, and the parameters L³³ and L³⁴, independently of one another and of the other parameters, denote H or F.

The liquid-crystal medium preferably comprises one or more compounds of the formula III-2a, which are preferably selected from the group of the compounds of the formulae III-2a-1 to III-2a-6:

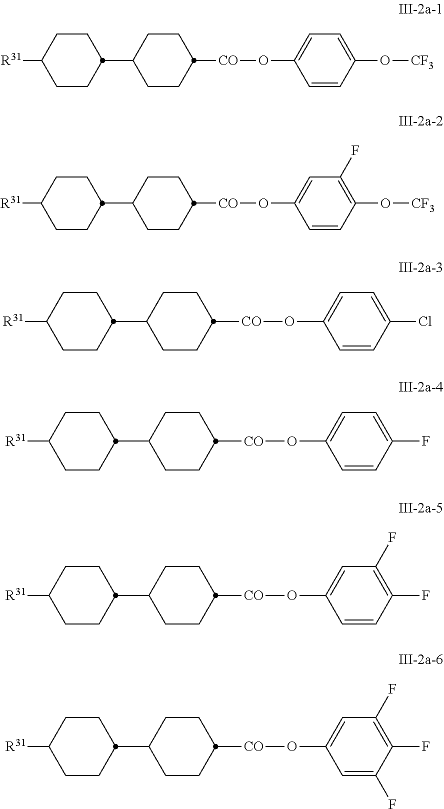

in which R³¹ has the meaning indicated above.

The liquid-crystal medium preferably comprises one or more compounds of the formula III-2b, which are preferably selected from the group of the compounds of the formulae III-2b-1 to III-2b-4, preferably III-2b-4:

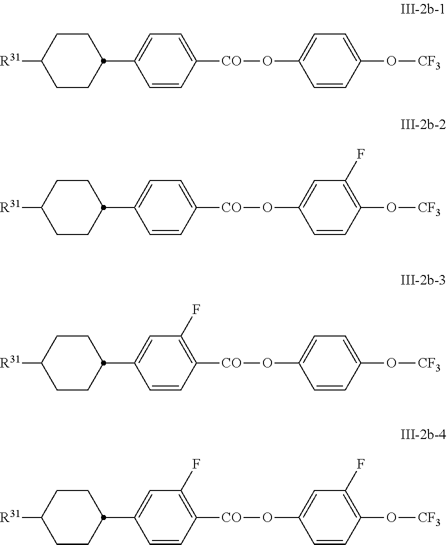

in which R³¹ has the meaning indicated above.

Alternatively, or in addition to the compounds of the formulae III-1 and/or III-2, the media in accordance with the present invention preferably comprise one or more compounds of the formula III-3

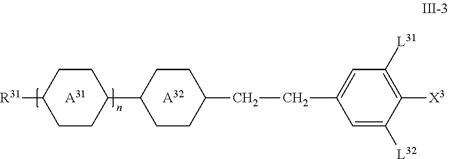

in which the parameters have the respective meanings indicated above under formula III.

These compounds are preferably selected from the group of the formulae III-3a and III-3b:

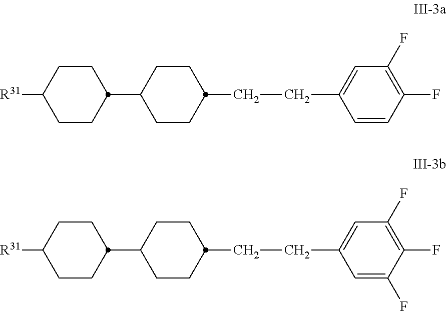

in which R³¹ has the meaning indicated above.

The compounds of the formulae II and/or III are preferably employed in concentrations of 1-10% by weight, in particular 1.5-5% by weight and very particularly preferably 1.5-3% by weight.

Further preferred is a liquid-crystalline medium, which comprises additionally to the above described dielectrically positive or negative compounds one or more compounds of the formula Z,

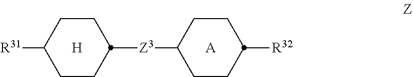

in which
R³¹ and R³² each, independently of one another, denote a straight-chain alkyl, alkoxy, alkenyl, alkoxyalkyl or alkoxy radical having up to 12 C atoms, and

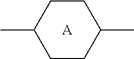

denotes

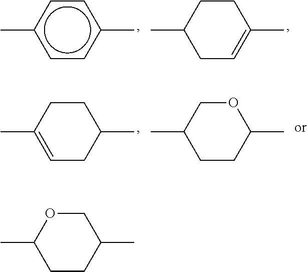

Z³ denotes a single bond, CH₂CH₂, CH═CH, CF₂O, OCF₂, CH₂O, OCH₂, COO, OCO, C₂F₄, C₄H₈, or CF═CF.

Preferred compounds of the formula Z are indicated below:

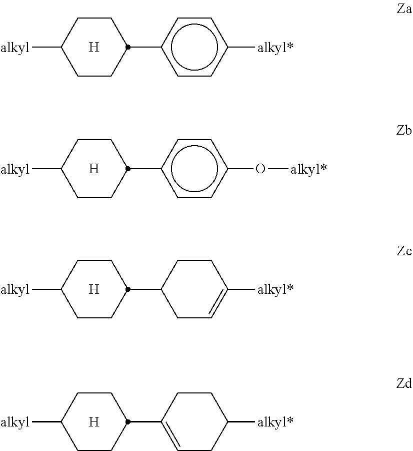

in which
alkyl and
alkyl* each, independently of one another, denote a straight-chain alkyl radical having 1-6 C atoms.

The medium according to the invention preferably comprises at least one compound of the formula Za and/or formula Zb.

If present, the proportion of compounds of the formula Z in the mixture as a whole is preferably at least 5% by weight

Further preferred is a liquid-crystalline medium, which comprises additionally to the above described dielectrically positive or negative compounds one or more compounds of the formula

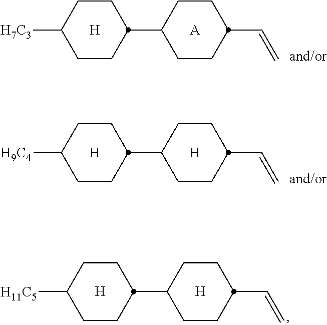

and if present, preferably in total amounts of ≥5% by weight, in particular ≥10% by weight.

Preference is furthermore given to mixtures according to the invention comprising the compound (acronym: CC-3-V1)

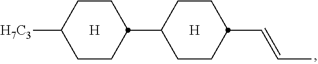

and if present, preferably in amounts of 1-20% by weight.

Preferred mixtures comprise 1-30% by weight, preferably 5-25% by weight, in particular 10-20% by weight, of the compound of the formula (acronym: CC-3-V)

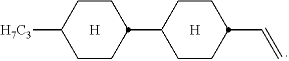

Preference is furthermore given to mixtures which comprise a compound of the formula (acronym: CC-3-V)

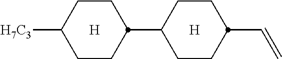

and/or a compound of the formula (acronym: CC-5-V)

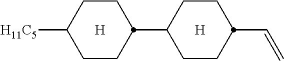

and/or a compound of the formula (acronym: CC-3-V1)

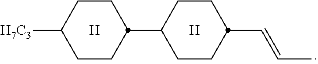

Further preferred is a liquid-crystalline medium, which comprises additionally to the above described dielectrically positive or negative compounds one or more biphenyls of the formulae B-1 to B-3,

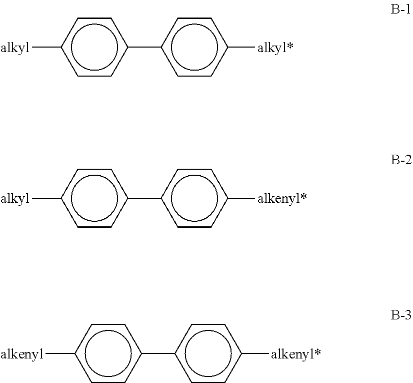

in which
alkyl and alkyl* each, independently of one another, denote a straight-chain alkyl radical having 1-6 C atoms, and
alkenyl and alkenyl*each, independently of one another, denote a straight-chain alkenyl radical having 2-6 C atoms.

The proportion of the biphenyls of the formulae B-1 to B-3 in the mixture as a whole is preferably at least 3% by weight, in particular ≥5% by weight.

Of the compounds of the formulae B-1 to B-3, the compounds of the formula B-2 are particularly preferred.

Particularly preferred biphenyls are

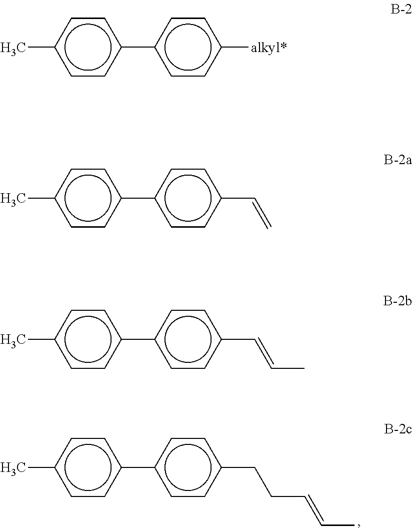

in which alkyl* denotes an alkyl radical having 1-6 C atoms. The medium according to the invention particularly preferably comprises one or more compounds of the formulae B-1a and/or B-2c.

Further preferred is a liquid-crystalline medium, which comprises additionally to the above described dielectrically positive or negative compounds one or more compounds of the formulae O-1 to O-19,

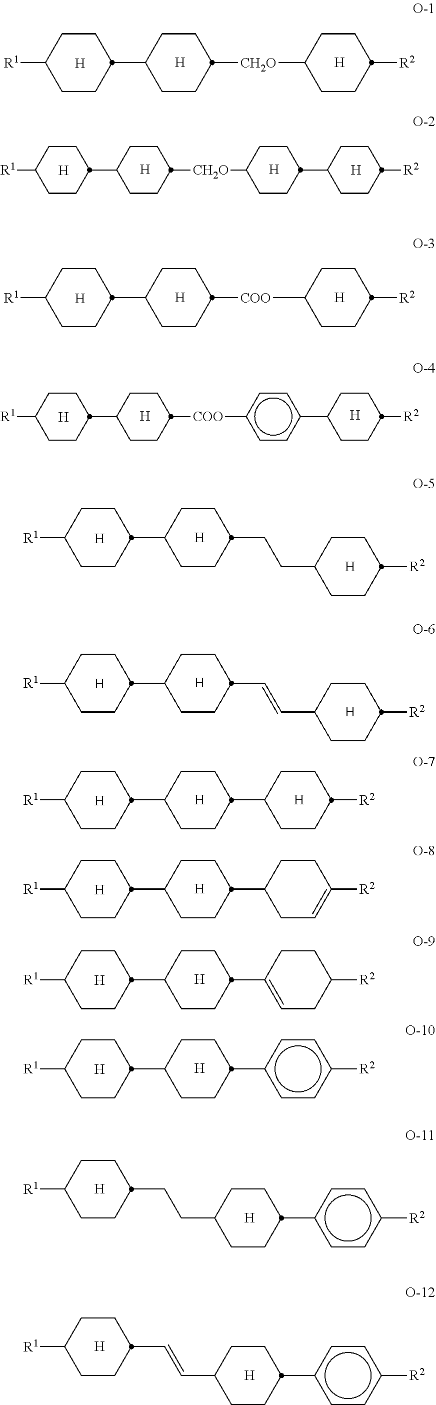

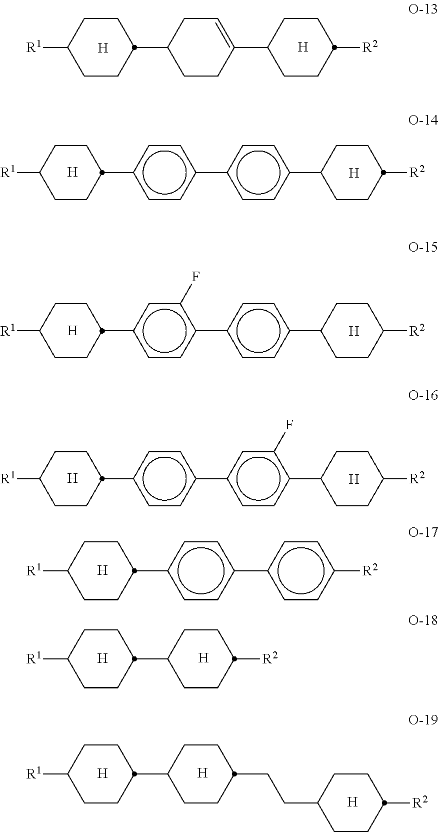

in which R¹ and R² have the meanings indicated for R^{2A}. R¹ and R² preferably each, independently of one another, denote straight-chain alkyl or alkenyl.

Preferred media comprise one or more compounds of the formulae O-1, O-3, O-4, O-6, O-7, O-10, O-11, O-12, O-14, O-15, O-16, O-17 and/or O-18.

Mixtures according to the invention very particularly preferably comprise the compounds of the formula O-10, O-12, O-16, O-17 and/or O-18, and if present, in amounts of 2-15%.

Preferred compounds of the formulae O-10 and O-18 are indicated below:

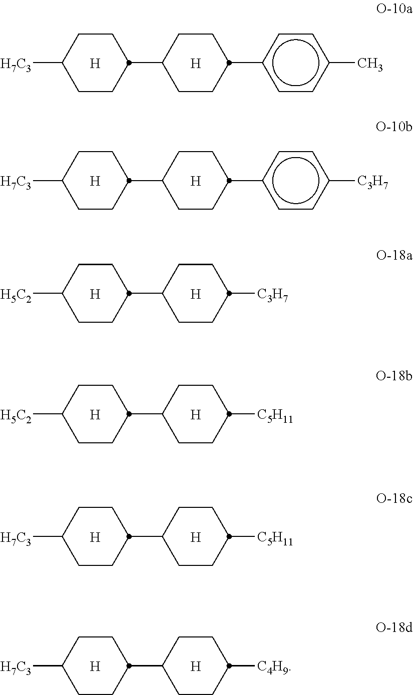

Very particularly preferred mixtures comprise the compounds O-10a and O-17a:

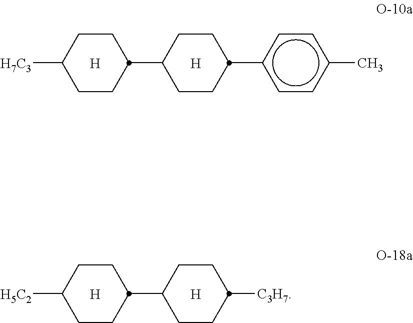

Very particularly preferred mixtures comprise the compounds O-10b and O-17a:

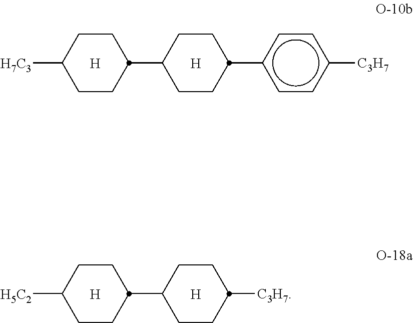

Preferred mixtures comprise at least one compound selected from the group of the compounds

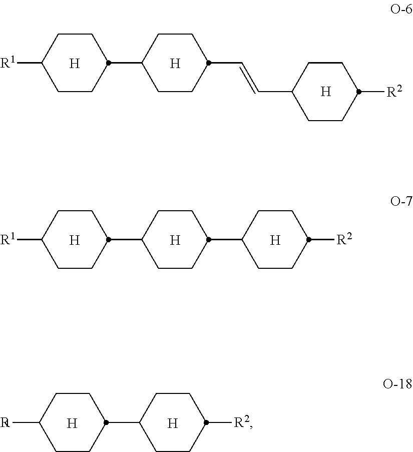

in which R¹ and R² have the meanings indicated above. Preferably in the compounds O-6, O-7 and O-17, R¹ denotes alkyl or alkenyl having 1-6 or 2-6 C atoms respectively and R² denotes alkenyl having 2-6 C atoms.

Preferred mixtures comprise at least one compound of the formulae O-6a, O-6b, O-7a, O-7b, O-17e, O-17f, O-17g and O-17h:

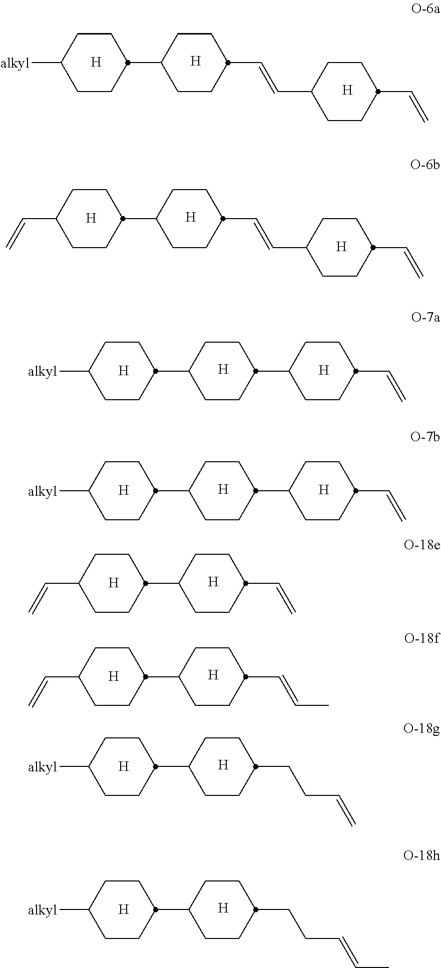

in which alkyl denotes an alkyl radical having 1-6 C atoms.

The liquid-crystalline media in accordance with the present invention preferably comprise one or more compounds selected from the group of the compounds of the formulae IA, IB and/or IC and one or more compounds selected from the group of the compounds of the formulae II and/or III. Besides the compounds of the formula IA, IB and/or IC, the liquid-crystal mixtures in accordance with the present invention preferably comprise compounds of the formulae II and/or III, preferably of the formula II. Further preferred liquid-crystalline media in accordance with the present invention preferably comprise one or more compounds selected from the group of the compounds of the formulae IA, one or more compounds selected from the group of the compounds of the formula IB, one or more compounds selected from the group of the compounds of the formulae IC and one or more compounds selected from the group of the compounds of the formula II.

The liquid-crystal mixtures in accordance with the present invention particularly preferably comprise additionally one or more compounds selected from the group of compounds of formulae B-2c, Zb, O-16, T-20, and/or T-21.

Further preferred liquid-crystalline media in accordance with the present invention preferably comprise
one, two, three, four, five or more compounds selected from the group of the compounds of the formulae IA, preferably selected from formulae IA-2and/or IA-8,
one, two, three, four, five or more compounds selected from the group of the compounds of the formula IB, preferably selected from formulae IB-2,
one or more compounds selected from the group of the compounds of the formulae IC, preferably selected from formula IC-1,
one, two, three, four, five or more compounds selected from the group of the compounds of the formula II, preferably selected from the group of the compounds of the formula II-1, more preferably selected from the group of the compounds of the formula II-1d,
optionally one, two, three, four, five or more compounds selected from the group of the compounds of the formula B-2, preferably selected from the group of the compounds of the formula B-2c,
optionally one, two, three, four, five or more compounds selected from the group of the compounds of the formula Zb,
optionally one, two, three, four, five or more compounds selected from the group of the compounds of the formulae G-20 and/or G-21,
optionally one, two, three, four, five or more compounds selected from the group of the compounds of the formula O-16, and
optionally one or more compounds selected from CC-3-V and/or CC-5-V,
   each in the preferred amounts as given above.

The media according to the invention may optionally comprise further liquid-crystal compounds in order to adjust the physical properties. Such compounds are known to the person skilled in the art. Their concentration in the media in accordance with the present invention is preferably 0% to approximately 30%, more preferably approximately 0.1% to approximately 20% and very preferably approximately 1% to approximately 15%.

The liquid-crystalline medium in accordance with the present invention optionally comprises further compounds, for example stabilisers, and or antioxidants. They are preferably employed in a concentration of 0% to approximately 30%, particularly preferably 0% to approximately 15%, and very particularly preferably 0% to approximately 5%.

The liquid-crystal media according to the present invention are prepared in a manner conventional per se. In general, the desired amount of the components used in lesser amount is dissolved in the components making up the principal constituent, preferably at elevated temperature. It is also possible to mix solutions of the components in an organic solvent, for example in acetone, chloroform or methanol, and to remove the solvent again, for example by distillation, after thorough mixing. It is furthermore possible to prepare the mixtures in other conventional manners, for example using pre-mixes, for example homologue mixtures, or using so-called “multibottle” systems.

A typical method of production of a medium according to the present invention comprises the step of mixing one or more dielectrically negative liquid crystalline compounds with one or more dielectrically positive liquid crystalline compounds.

Further, the invention relates to the use of the medium as described above and below in a light modulation element. Preferably, such light modulation element comprises a pair of substrates, an electrode structure, which is capable to allow the application of an electric field, which is substantially parallel to the substrate main plane, at least one planar alignment layer, at least one homeotropic alignment layer and a medium as described above and below.

In a preferred embodiment of the invention, the layer of the liquid-crystalline medium is arranged between two substrate layers.

In accordance with the invention, the substrate material is preferably selected each and independently from another, from polymeric materials, glass or quartz plates.

Suitable and preferred polymeric substrate materials are, for example, films of cyclo olefin polymer (COP), cyclic olefin copolymer (COC), polyester such as polyethyleneterephthalate (PET) or polyethylene-naphthalate (PEN), polyvinylalcohol (PVA), polycarbonate (PC) or triacetylcellulose (TAC), very preferably PET or TAC films. PET films are commercially available for example from DuPont Teijin Films under the trade name Melinex®.

COP films are commercially available for example from ZEON Chemicals L.P. under the trade name Zeonor® or Zeonex®. COC films are commercially available for example from TOPAS Advanced Polymers Inc. under the trade name Topas®.

Preferably, both substrates are glass plates.

In a preferred embodiment, the substrates are arranged with a separation in the range from approximately 1 μm to approximately 50 μm from one another, preferably in the range from approximately 2 μm to approximately 40 μm from one another, and more preferably in the range from approximately 3 μm to approximately 30 μm from one another. The layer of the liquid-crystalline medium is thereby located in the interspace.

The substrate layers can be kept at a defined separation from one another, for example, by spacers or electrodes, which extend through the full cell thickness or projecting structures in the layer. Typical spacer materials are commonly known to the expert, as for example spacers made of plastic, silica, epoxy resins, etc.

The light modulation element in accordance with the present invention as described above and below, comprises one planar alignment layer and one homeotropic alignment layer.

Typical homeotropic alignment layer materials are commonly known to the expert, such as, for example, layers made of alkoxysilanes, alkyltrichlorosilanes, CTAB, lecithin or polyimides, preferably polyimides, such as, for example JALS-2096-R1.

Suitable planar polyimides are commonly known to the expert, such as, for example, AL-3046 or AL-1254 both commercially available from JSR.

Typically, the alignment layer materials can be applied onto the substrates or electrode structures by conventional coating techniques like spin coating, roll-coating, dip coating or blade coating, by vapour deposition or conventional printing techniques that are known to the expert, like for example screen printing, offset printing, reel-to-reel printing, letter press printing, gravure printing, rotogravure printing, flexographic printing, intaglio printing, pad printing, heat-seal printing, ink-jet printing or printing by means of a stamp or printing plate.

The planar alignment layer is preferably processed by rubbing or photo-alignment techniques known to the skilled person, in order to achieve a uniform preferred direction of the ULH texture, preferably by rubbing techniques. Accordingly, a uniform preferred direction of the ULH texture can be achieved without any physical treatment of the cell like shearing of the cell (mechanical treatment in one direction), etc. The rubbing direction is uncritical and mainly influences only the orientation of polarizers is applied. Typically, the rubbing direction is in the range of +/−45°, more preferably in the range of +/−20°, even more preferably, in the range of +/−10, and in particular, in the range of the direction +/−5° with respect to substrates main plane.

In a preferred embodiment, the device according to the present invention comprises an electrode structure, which is capable to allow the application of an electric field, which is substantially parallel to the substrate main plane or the layer of the LC medium, or has at least a substantial component in that direction.

Unless the entire display assembly is intended to be flexible, preferably the electrodes may be formed on a low cost rigid substrate, which will further increase the durability of the device. In a preferred embodiment, the substrate carries patterns of parallel electrodes, for example, in a comb-like electrode arrangement.

Other suitable electrode structures are commonly known to the expert and for example disclosed in WO 2004/029697 A1.

In another preferred embodiment, one of the substrates includes a pixel electrode and a common electrode for generating an electric field substantially parallel to a surface of the first substrate in the pixel region.

Different kinds of devices having at least two electrodes on one substrate are known to the skilled person wherein the most important difference is that either both the pixel electrode and the common electrode are structured, as it is typical for IPS displays, or only the pixel electrode is structured and the common electrode is unstructured, which is the case for FFS displays.

In a further preferred embodiment, the in-plane electrode structure is selected from interdigitated electrodes, IPS electrodes, FFS electrodes or comb like electrodes, preferably interdigitated electrodes or comb like electrodes. In this connection, document WO 2008/104533 A1 describes arrangements where the electrodes are arranged as an IPS electrode and arrangements where an additional base electrode is disposed on the same substrate, as a fringe-field switching (FFS) electrode.

Suitable electrode materials are commonly known to the expert, as for example electrodes made of conductive polymers, metal or metal oxides, such as, for example, transparent indium tin oxide (ITO), which is preferred according to the present invention.

In a preferred embodiment, the electrodes can have a circular cross-section, in the form of a solid wire or a cylinder, or the electrodes can have a rectangular or an almost rectangular cross section. Especially preferred is a rectangular or almost rectangular cross section of the electrodes.

The gap between the electrodes is preferably in the range from approximately 1 μm to approximately 50 μm, more preferably in the range from approximately 5 μm to approximately 25 μm, and even more preferably in the range from approximately 7 μm to approximately 12 μm

The width of the electrodes is preferably in the range from approximately 1 μm to approximately 50 μm, more preferably in the range from approximately 5 μm to approximately 25 μm, and even more preferably in the range from approximately 7 μm to approximately 12 μm

As commonly known, the electrode structure can typically be provided on the substrate by current lithographic techniques.

In a preferred embodiment, the electrodes of the light modulation element are connected with an electrically switching element, such as a thin film transistor (TFT) or a thin film diode (TFD).

In a preferred embodiment, the electrode structure is in direct contact with the liquid crystalline medium.

In another preferred embodiment, the substrate and/or the electrode structure is covered with a thin homeotropic alignment layer to control the alignment of the liquid crystal material.

Preferably, the electrodes of the light modulation element are associated with a switching element, such as a thin film transistor (TFT) or thin film diode (TFD).

In a further preferred embodiment of the invention, the light modulation element comprises two or more polarisers, at least one of which is arranged on one side of the layer of the liquid-crystalline medium and at least one of which is arranged on the opposite side of the layer of the liquid-crystalline medium. The layer of the liquid-crystalline medium and the polarisers here are preferably arranged parallel to one another.

The polarisers can be linear polarisers. Preferably, precisely two polarisers are present in the light modulation element. In this case, it is furthermore preferred for the polarisers either both to be linear polarisers. If two linear polarisers are present in the light modulation element, it is preferred in accordance with the invention for the polarisation directions of the two polarisers to be crossed.

It is furthermore preferred in the case where two circular polarisers are present in the light modulation element for these to have the same polarisation direction, i.e. either both are right-hand circular-polarised or both are left-hand circular-polarised.

The polarisers can be reflective or absorptive polarisers. A reflective polariser in the sense of the present application reflects light having one polarisation direction or one type of circular-polarised light, while being transparent to light having the other polarisation direction or the other type of circular-polarised light. Correspondingly, an absorptive polariser absorbs light having one polarisation direction or one type of circular-polarised light, while being transparent to light having the other polarisation direction or the other type of circular-polarised light. The reflection or absorption is usually not quantitative; meaning that complete polarisation of the light passing through the polariser does not take place.

For the purposes of the present invention, both absorptive and reflective polarisers can be employed. Preference is given to the use of polarisers, which are in the form of thin optical films. Examples of reflective polarisers which can be used in the light modulation element according to the invention are DRPF (diffusive reflective polariser film, 3M), DBEF (dual brightness enhanced film, 3M), DBR (layered-polymer distributed Bragg reflectors, as described in U.S. Pat. Nos. 7,038,745 and 6,099,758) and APF (advanced polariser film, 3M).

Examples of absorptive polarisers, which can be employed in the light modulation elements according to the invention, are the Itos XP38 polariser film and the Nitto Denko GU-1220DUN polariser film. An example of a circular polariser, which can be used in accordance with the invention, is the APNCP37-035-STD polariser (American Polarizers). A further example is the CP42 polariser (ITOS).

Accordingly, a further preferred light modulation element according to the present invention comprises, preferably consists of, the following layer stack:
polariser,
substrate,
processed planar alignment layer,
liquid crystalline medium,
homeotropic alignment layer,
electrode structure,
substrate, and
polariser.

The light modulation element may furthermore comprise filters, which block light of certain wavelengths, for example, UV filters. In accordance with the invention, further functional layers commonly known to the expert may also be present, such as, for example, protective films and/or compensation films.

The light modulation elements as described above and below are beneficially obtainable by commonly known methods of mass production.

Therefore, the invention relates to a method of production of a light modulation element as described above and below comprising the steps of
a. providing an electrode structure on at least one of the substrates,
b. providing at least one planar alignment layer on one of the substrates,
c. providing at least one homeotropic alignment layer on the other substrate,
d. providing a layer of a medium as described above and below on one of the substrates, and
e. assembling the cell.

In a preferred embodiment of the present invention, the liquid crystal composition may be interposed between the first and second substrates by combining the second substrate to the first substrate after loading the liquid crystal composition on the first substrate.

In a further preferred embodiment, the liquid crystal is dispensed dropwise onto a first substrate in a process known as “one drop filling” (ODF) process, as disclosed in for example JPS63-179323 and JPH10-239694, or using the Ink Jet Printing (IJP) method.

In an alternative embodiment, the liquid crystal composition is injected between the first and second substrates or is filled into the assembled cell by capillary force after combining the first and second substrates. Accordingly, the steps d) and e) can be adapted depending on the filling method.

The functional principle of the light modulation element according to the invention will be briefly explained below. It is noted that no restriction of the scope of the claimed invention, which is not present in the claims, is to be derived from the comments on the assumed way of functioning.

The light transmission of the device according to the invention is dependent on the applied electric field. In a preferred embodiment, the light transmission of the device is high when an electric field is applied and low in the initial state when no electric field is applied.

In a preferred embodiment, the device according to the invention has a boundary state A and a boundary state B. For the purposes of the present application, the term boundary state is taken to mean a state in which the transmission reaches a maximum or minimum value and changes no further or virtually no further on a further reduction or increase in the of the applied electric field.

The light modulation element preferably has the boundary state A with a transmission T_{A} when no electrical field is applied, the so called off state, in which the liquid crystal medium is essentially in the HAN alignment state.

The light modulation element preferably has another boundary state B when an electric field is applied, the so called “on state”, whereby

T_{A}<T_{B}.

The light modulation element preferably exhibits an induced retardation in the “on”-state in the range from approximately 1 nm to approximately 500 nm, more preferably from approximately 1 nm to approximately 400 nm, even more preferably from approximately 1 nm to approximately 300 nm.

The low applied electric fields required to switch the light modulation elements according to the present invention have several advantages. The inter-electrode spacing is substantially larger than the inter-electrode spacing found in current IPS devices. Accordingly, lower cost patterning of the electrodes, improved yields, increased optical apertures and lower driving voltages are some benefits from the light modulation element according to the present invention.

The HAN aligned “off state” of the device provides excellent optical extinction and therefore a favourable contrast.

Due to the orientations of the alignment layers, the liquid crystalline medium adopts a hybrid alignment (HAN), i.e. at the substrate bearing planar alignment layer the alignment of the adjacent liquid crystal molecules is planar while at the other substrate bearing the homeotropic alignment layer the alignment of the adjacent liquid crystal molecules is homeotropic. Such elastic deformation of the nematic bulk layer gives rise to a flexoelectric polarization (P_{f}), since e₃ is dominant at homeotropic surface and e₁ dominates at planar surface:

P_{f}=e₁n(div n)+e₃(curl n)×n

where e₁ is the splay flexoelectric coefficient, e₃ is the bend flexoelectric coefficient, and n (div n), and (curl n)×n are the splay and bend vectors respectively.

Preferably, the elastic deformation and the flexoelectric polarization are lying in the same plane parallel to the electrode pattern and perpendicular to the cell substrates.

When a DC electric field is applied, the flexoelectric polarization couples linearly to the applied electric field (E) providing a fast switching of the liquid crystals whereby the flexoelectric response provides polarity dependent switching, opening the opportunity for active on- and off-switching resulting in significantly improved response speeds.

The light modulation element according to the present invention can be operated with a conventional driving waveform as commonly known by the expert.

However, in a preferred embodiment according to the present invention an alternative driving waveform can be utilized. Therefore, a short duration ‘kick’ or pre-pulse that is a number of times larger than the amplitude of the DC pulse required to obtain the desired amplitude of switching can be used to simulate the presence of a higher voltage, thus allowing a faster switching speed to be obtained.

Typically, the total switching time (tₒₙ+t_{off}) of a light modulation element is in the range from 1 to 20 ms, preferably in the range from 1 to 10 ms, more preferably in the range from 1 to 5 ms.

The required applied electric field strength is mainly dependent on the electrode gap. In a preferred embodiment, the applied electric field strengths are preferably lower than approximately 0.5 V/μm⁻¹, preferably lower than approximately 0.2 V/μm⁻¹ and more preferably lower than approximately 0.1 V/μm⁻¹.

In a preferred embodiment, the applied driving voltage is in the range from 0 V to approximately 10 V, more preferably in the range from approximately 1 V to approximately 7V, and even more preferably in the range from approximately 1.5 V to approximately 4.V.

The light modulation element of the present invention can be used in various types of optical and electro-optical devices.

Therefore, the invention relates to the use of a light modulation element as described above and below, in electro-optical devices and to electro-optical devices, such as an LCD, comprising at least one light modulation element as described above and below.

Said optical and electro optical devices include, without limitation electro-optical displays, liquid crystal displays (LCDs), non-linear optic (NLO) devices, optical information storage devices, light shutters and Smart Windows, privacy windows, virtual reality devices and augmented reality devices.

It will be appreciated that many of the features described above, particularly of the preferred embodiments, are inventive in their own right and not just as part of an embodiment of the present invention.

Independent protection may be sought for these features in addition to, or alternative to any invention presently claimed.

It will be appreciated that variations to the foregoing embodiments of the invention can be made while still falling within the scope of the invention. Alternative features serving the same, equivalent or similar purpose may replace each feature disclosed in this specification, unless stated otherwise. Thus, unless stated otherwise, each feature disclosed is one example only of a generic series of equivalent or similar features.

All of the features disclosed in this specification may be combined in any combination, except combinations where at least some of such features and/or steps are mutually exclusive. In particular, the preferred features of the invention are applicable to all aspects of the invention and may be used in any combination. Likewise, features described in non-essential combinations may be used separately (not in combination).

Without further elaboration, it is believed that one skilled in the art can, using the preceding description, utilize the present invention to its fullest extent. The following examples are, therefore, to be construed as merely illustrative and not limitative of the remainder of the disclosure in any way whatsoever.

The parameter ranges indicated in this application all include the limit values including the maximum permissible errors as known by the expert. The different upper and lower limit values indicated for various ranges of properties in combination with one another give rise to additional preferred ranges.

In the present application and especially in the following examples, the structures of the liquid crystal compounds are represented by abbreviations, which are also called “acronyms”. The transformation of the abbreviations into the corresponding structures is straightforward according to the following three tables A to C. Table A lists the symbols used for the ring elements, table B those for the linking groups and table C those for the symbols for the left hand and the right-hand end groups of the molecules.

TABLE A
Ring Elements

| | | | |
|---|---|---|---|
| C | 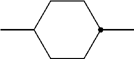 | P | 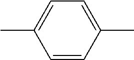 |
| D | 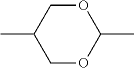 | DI | 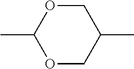 |
| A | 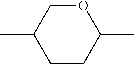 | AI | 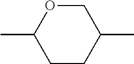 |
| G | 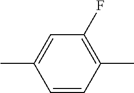 | GI | 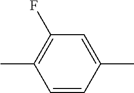 |
| U | 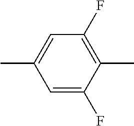 | UI | 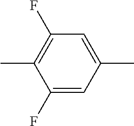 |
| Y | 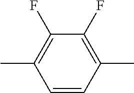 | | |
| M | 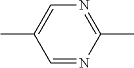 | MI | 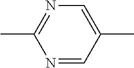 |
| N | 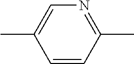 | NI | 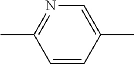 |
| np | 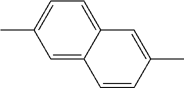 | | |
| n3f | 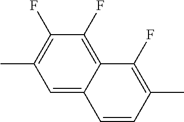 | n3fI | 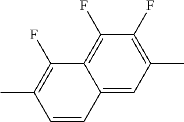 |
| th | 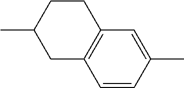 | thI | 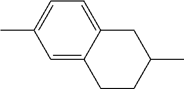 |
| th2f | 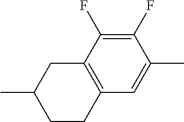 | th2fI | 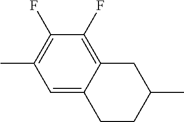 |
| o2f | 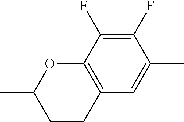 | o2fI | 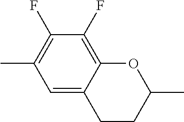 |
| dh | 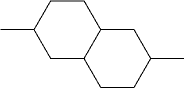 | | |
| K | 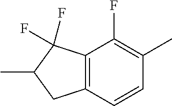 | KI | 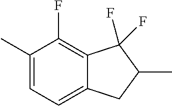 |
| L | 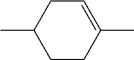 | LI | 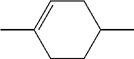 |
| F | 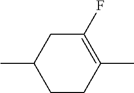 | FI | 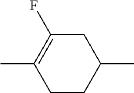 |

TABLE B
Linking Groups

| | | | |
|---|---|---|---|
| E | —CH₂—CH₂— | | |
| V | —CH═CH— | | |
| T | —C≡C— | | |
| W | —CF₂—CF₂— | | |
| B | —CF═CF— | | |
| Z | —CO—O— | ZI | —O—CO— |
| X | —CF═CH— | XI | —CH═CF— |
| O | —CH₂—O— | OI | —O—CH₂— |
| Q | —CF₂—O— | QI | —O—CF₂— |

TABLE C
End Groups

| Left hand side, used alone or in | | Right hand side, used alone or in | |
|---|---|---|---|
| combination with others | | combination with others | |
| -n- | CₙH₂ₙ₊₁— | -n | —CₙH₂ₙ₊₁ |
| -nO- | CₙH₂ₙ₊₁—O— | -nO | —O—CₙH₂ₙ₊₁ |
| -V- | CH₂═CH— | -V | —CH═CH₂ |
| -nV- | CₙH₂ₙ₊₁—CH═CH— | -nV | —CₙH₂ₙ—CH═CH₂ |
| -Vn- | CH₂═CH—CₙH₂ₙ— | -Vn | —CH═CH—CₙH₂ₙ₊₁ |
| -nVm- | CₙH₂ₙ₊₁—CH═CH—CₘH₂ₘ— | -nVm | —CₙH₂ₙ—CH═CH—CₘH₂ₘ₊₁ |
| -N- | N≡C— | -N | —C═N |
| -S- | S═C═N— | -S | —N═C═S |
| -F- | F— | -F | —F |
| -CL- | Cl— | -CL | —Cl |
| -M- | CFH₂— | -M | —CFH₂ |
| -D- | CF₂H— | -D | —CF₂H |
| -T- | CF₃— | -T | —CF₃ |
| -MO- | CFH₂O— | -OM | —OCFH₂ |
| -DO- | CF₂HO— | -OD | —OCF₂H |
| -TO- | CF₃O— | -OT | —OCF₃ |
| -A- | H—C≡C— | -A | —C≡C—H |
| -nA- | CₙH₂ₙ₊₁—C≡C— | -An | —C≡C—CₙH₂ₙ₊₁ |
| -NA- | N≡C—C≡C— | -AN | —C≡C—C≡N |

| | |
|---|---|
| Left hand side, used in combination | Right hand side, used in |
| with others only | combination with others only |

| | | | |
|---|---|---|---|
| - . . . n . . . - | —CₙH₂ₙ— | - . . . n . . . | —CₙH₂ₙ— |
| - . . . M . . . - | —CFH— | - . . . M . . . | —CFH— |
| - . . . D . . . - | —CF₂— | - . . . D . . . | —CF₂— |
| - . . . V . . . - | —CH═CH— | - . . . V . . . | —CH═CH— |
| - . . . Z . . . - | —CO—O— | - . . . Z . . . | —CO—O— |
| - . . . ZI . . . - | —O—CO— | - . . . ZI . . . | —O—CO— |
| - . . . K . . . - | —CO— | - . . . K . . . | —CO— |
| - . . . W . . . - | —CF═CF— | - . . . W . . . | —CF═CF— |

wherein n und m each are integers between 1 and 12 and three points “. . .” indicate a space for other symbols of this table.

### EXAMPLES

### Test Cell

A test cell with the following parameters is prepared:

Substrate: AF-glass

IPS electrode structure: 4 μm electrode width and 8 μm electrode spacing

Alignment layer, bottom substrate provided with the electrode structure: homogenous PI, AL-3046 (commercially available from JSR, Japan)

Alignment layer, top substrate:

Homeotropic PI, AL-60702 (commercially available from JSR, Japan).

### Mixture M1

The following mixture M-1 is prepared

| Composition | | | | | |
|---|---|---|---|---|---|
| Compound | | | | | |
| No. | Abbreviation | Conc./% | Physical Properties | | |
| | | | T(N, I) = | 79 | ° C. |
| 1 | CY-3-O2 | 16.0 | nₑ (20° C., 589.3 nm) = | 1.621 | |
| 2 | CY-5-O2 | 13.0 | nₒ (20° C., 589.3 nm) = | 1.487 | |
| 3 | CCY-3-O3 | 12.0 | Δn (20° C., 589.3 nm) = | 0.134 | |
| 4 | CCY-4-O2 | 8.0 | | | |
| 5 | CPY-2-O2 | 12.0 | ε_{\| \|} (20° C., 1 kHz) = | 7.8 | |
| 6 | CPY-3-O2 | 12.0 | ε_{⊥} (20° C., 1 kHz) = | 10.3 | |
| 7 | CC-5-V | 3.0 | Δε (20° C., 1 kHz) = | −2.5 | |

| | | |
|---|---|---|
| 8 | PYP-2-4 | 12.0 |
| 9 | PUQU-3-F | 6.00 |
| 10 | PUQU-2-F | 6.00 |
| Σ | | 100.0 |

### Mixture M-2

The following mixture M-2 is prepared

| Composition | | | | | |
|---|---|---|---|---|---|
| Compound | | | | | |
| No. | Abbreviation | Conc./% | Physical Properties | | |
| | | | T(N, I) = | 106 | ° C. |
| 1 | CC-3-V | 13.0 | nₑ (20° C., 589.3 nm) = | 1.719 | |
| 2 | CPGP-4-3 | 5.0 | nₒ (20° C., 589.3 nm) = | 1.517 | |
| 3 | CPGP-5-2 | 5.0 | Δn (20° C., 589.3 nm) = | 0.202 | |
| 4 | CPGP-5-3 | 3.0 | | | |
| 5 | CP-3-O1 | 14.0 | ε_{\| \|} (20° C., 1 kHz) = | 3.4 | |
| 6 | PGP-1-2V | 9.0 | ε_{⊥} (20° C., 1 kHz) = | 3.0 | |
| 7 | PGP-2-2V | 9.0 | Δε (20° C., 1 kHz) = | 0.4 | |

| | | |
|---|---|---|
| 8 | PGP-3-2V | 8.0 |
| 9 | PGP-2-3 | 5.0 |
| 10 | PGP-2-4 | 5.0 |
| 11 | PGP-2-5 | 10.0 |
| 12 | PP-1-2V1 | 14.0 |
| Σ | | 100.0 |

### Mixture M-3

The mixture M-3 is prepared by mixing 0.029g of mixture M-1 (14%-w/w) with 0.176 g of mixture M-2 (86%-w/w) resulting in mixture M-3 having the following dielectric characteristics:

| | |
|---|---|
| ε_{∥} (20° C., 1 kHz) ═ | 3.752 |
| ε_{⊥} (20° C., 1 kHz) ═ | 3.736 |
| Δε (20° C., 1 kHz) ═ | 0.016 |

### Comparison Example 1

A test cell as described above is assembled resulting in a cell gap of 2.47 μm. The cell is capillary filled with mixture M-1.

The switching speeds tₒₙ and t_{off} are determined in dependence of the applied voltage.

| Applied voltage (V) (0-peak) | tₒₙ (ms) | t_{off} (ms) |
|---|---|---|
| 2.08 | 42 | 15 |
| 4.12 | 35 | 10.7 |
| 6.08 | 23 | 10.5 |
| 8.40 | 14 | 11.3 |
| 10.4 | 8.2 | 11.5 |
| 12.2 | 5.8 | 11.9 |
| 14.8 | 4.1 | 11.7 |
| 16.8 | 2.5 | 12.1 |
| 18.6 | 1.9 | 12.3 |

As can be seen from the table given above, the test cell shows a strong dependence for tₒₙ with an increasing applied field, and almost no dependence with t_{off}, indicating the expected dielectric type switching mechanism.

### Example 1

A test cell as described above is assembled resulting in a cell gap of 2.85 μm. The cell is capillary filled with mixture M-3.

The switching speed tₒₙ and t_{off} are determined in dependency of the applied voltage.

| Applied voltage (V) (0-peak) | tₒₙ (ms) | t_{off} (ms) |
|---|---|---|
| 10.6 | 11.4 | 5.3 |
| 15.6 | 11.3 | 5.4 |
| 21.0 | 10.3 | 5.6 |
| 26.0 | 10.2 | 5.3 |
| 31.0 | 9.5 | 5.4 |
| 36.0 | 12.9 | 5.0 |

As can be seen from the table given above, the test cell shows a much weaker dependence of the switching speed with applied field in comparison to comparison example 1, indicating that dielectric switching is not the key mechanism.

By using overdriving addressing or ‘kick addressing’, e.g. applying a high electric field for a short time period, such as for 21 V 0-peak the application of a 69.9 V ‘kick pulse’ for a short time at the front of the waveform, a tₒₙ under 1 ms can be achieved. Furthermore, by applying a negative kick pulse, an improvement of t_{off} below 1 ms can be achieved.

1. Medium comprising one or more dielectrically negative compounds and one or more dielectrical positive compounds, characterized in that the medium exhibits a dielectrically anisotropy (Δε) in the range from −0.25 to +0.25 determined at a frequency of 1 kHz and at 20° C.

2. Medium according to claim 1, comprising one or more dielectrical negative compounds selected from the group of the compounds of the formulae IA, IB and IC, 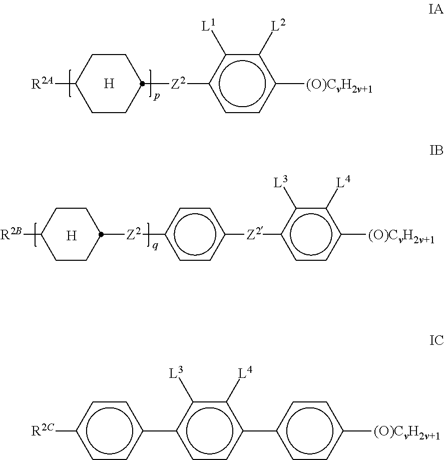
in which
R^{2A}, R^{2B} and R^{2C} each, independently of one another, denote H, an alkyl or alkenyl radical having up to 15 C atoms which is unsubstituted, monosubstituted by CN or CF₃ or at least monosubstituted by halogen, where, in addition, one or more CH₂ groups in these radicals may be replaced by —O—, —S—, 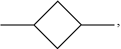
—C≡C—, —CF₂O—, —OCF₂—, —OC—O— or —O—CO— in such a way that O atoms are not linked directly to one another,
L¹⁻⁴ each, independently of one another, denote F, Cl, CF₃ or CHF₂,
Z² and Z^{2′} each, independently of one another, denote a single bond, —CH₂CH₂—, —CH═CH—, —CF₂O—, —OCF₂—, —CH₂O—, —OCH₂—, —COO—, —OCO—, —C₂F₄—, —CF═CF—, —CH═CHCH₂O—,
p denotes 0, 1 or 2,
q denotes 0 or 1, and
v denotes 1 to 6.

3. Medium according to claim 1, comprising one or more dielectrical positive compounds, which are selected from the group of compounds of formulae II and III, 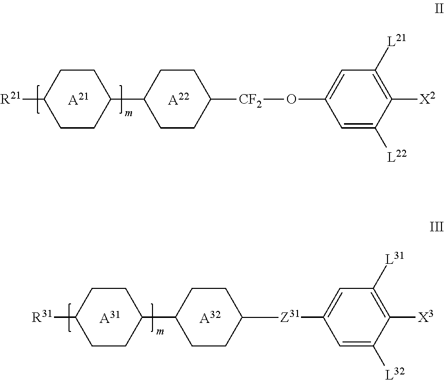
in which
R²¹ denotes alkyl, alkoxy, fluorinated alkyl or fluorinated alkoxy having 1 to 7 C atoms, alkenyl, alkenyloxy, alkoxyalkyl or fluorinated alkenyl having 2 to 7 C atoms and preferably alkyl or alkenyl, 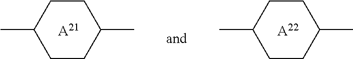
on each appearance, independently of one another, denote 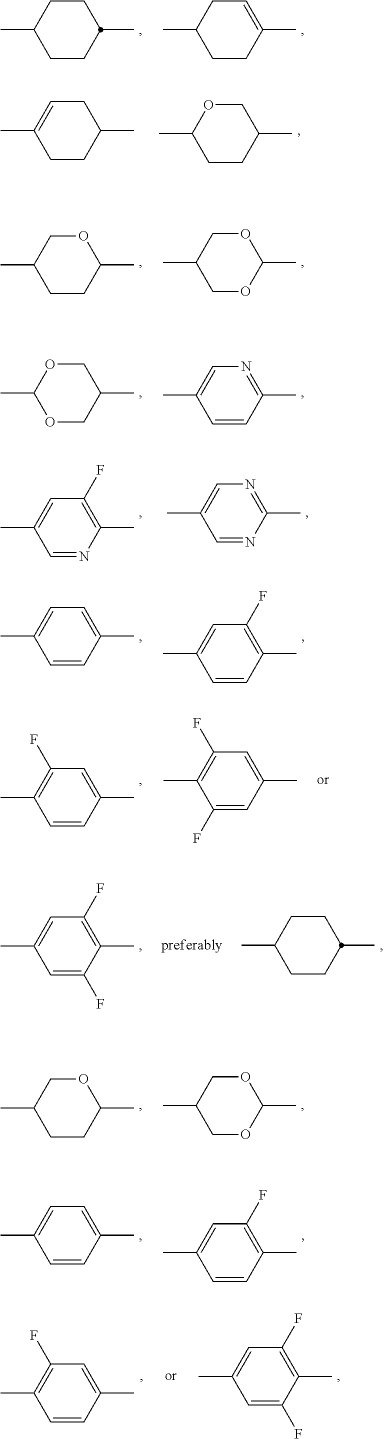
L²¹ and L²² denote H or F, preferably L²¹ denotes F,
X²¹ denotes halogen, halogenated alkyl or alkoxy having 1 to 3 C atoms or halogenated alkenyl or alkenyloxy having 2 or 3 C atoms, preferably F, Cl, —OCF₃, —O—CH₂CF₃, —O—CH═CH₂, —O—CH═CF₂ or —CF₃, very preferably F, Cl, —O—CH═CF₂ or —OCF₃,
m denotes 0, 1, 2 or 3, preferably 1 or 2 and particularly preferably 1,
R³¹ denotes alkyl, alkoxy, fluorinated alkyl or fluorinated alkoxy having 1 to 7 C atoms, alkenyl, alkenyloxy, alkoxyalkyl or fluorinated alkenyl having 2 to 7 C atoms and preferably alkyl or alkenyl, 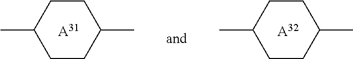
on each appearance, independently of one another, are 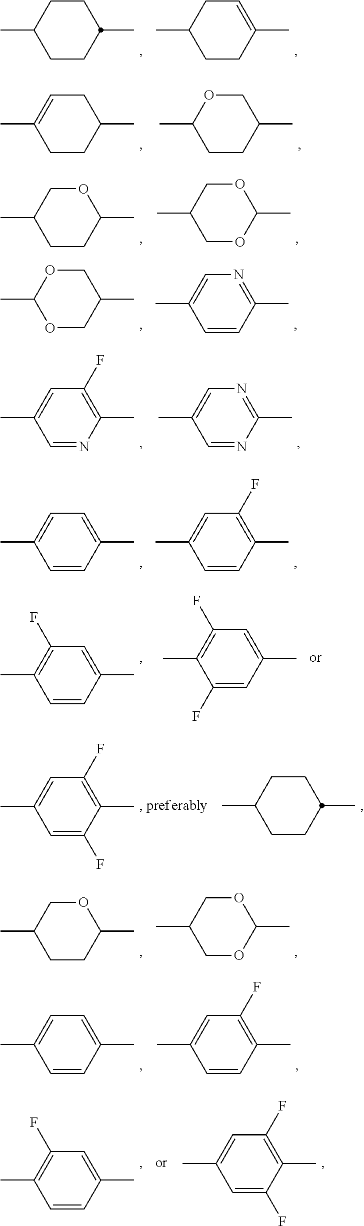
L³¹ and L³², independently of one another, denote H or F, preferably L³¹ denotes F,
X³¹ denotes halogen, halogenated alkyl or alkoxy having 1 to 3 C atoms or halogenated alkenyl or alkenyloxy having 2 or 3 C atoms, F, Cl, —OCF₃, —O—CH₂CF₃, —O—CH═CF₂, —O—CH═CH₂ or —CF₃, very preferably F, Cl, —O—CH═CF₂ or —OCF₃,
Z³¹ denotes —CH₂CH₂—, —CF₂CF₂—, —COO—, trans-CH═CH—, trans-CF═CF—, —CH₂O— or a single bond, preferably —CH₂CH₂—, —COO—, trans-CH═CH— or a single bond and very preferably —COO—, trans-CH═CH— or a single bond, and
n denotes 0, 1, 2 or 3, preferably 1 or 3 and particularly preferably 1.

4. Medium according to claim 1, wherein the liquid-crystalline medium comprises one or more compounds of formula IV 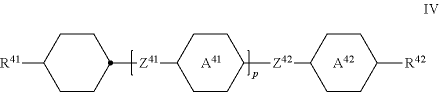
in which
R⁴¹ and R⁴² independently of one another, have the meaning indicated above for R²¹ under formula II, 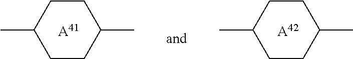
independently of one another and, if 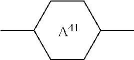
occurs twice, also these independently of one another, denote 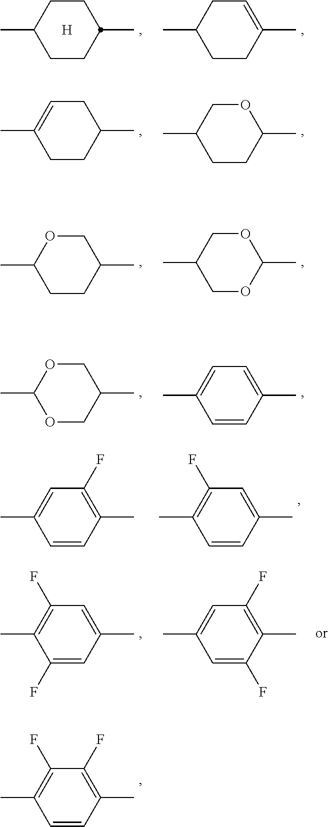
Z⁴¹ and Z⁴² independently of one another and, if Z⁴¹ occurs twice, also these independently of one another, denote —CH₂CH₂—, —COO—, trans-CH═CH—, trans-CF═CF—, —CH₂O—, —CF₂O—, —C≡C— or a single bond, and
p denotes 0, 1 or 2.

5. Medium according to claim 1, comprising one or more compounds of the formula V, 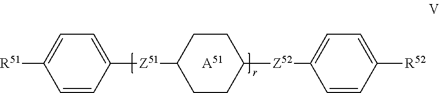
in which
R⁵¹ and R⁵² independently of one another, have the meanings indicated above for R²¹ under formula II, 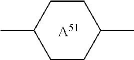
on each appearance, independently of one another, denotes 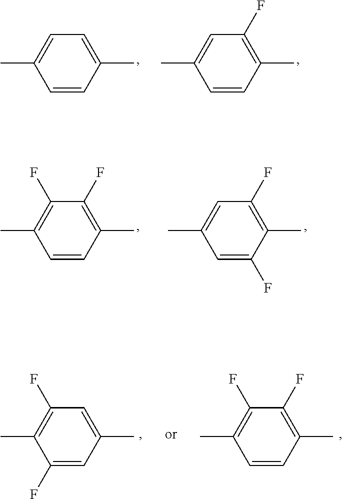
Z⁵¹ and Z⁵² independently of one another and, if Z⁵¹ occurs twice, also these independently of one another, denote —CH₂CH₂—, —COO—, trans-CH═CH—, trans-CF═CF—, —CH₂O—, —CF₂O— or a single bond, and
r denotes 0, 1 or 2.

6. Medium according to claim 1, wherein the amount of compounds of the formulae IA and/or IB and/or IC in the liquid-crystalline medium as a whole is at least 10%.

7. Medium according to claim 1, wherein the amount of compounds of the formulae II and/or III in the liquid-crystalline medium as a whole is in the range from 2 to 90%.

8. Medium according to claim 1, wherein the amount of compounds of the formulae IV and/or V in the liquid-crystalline medium as a whole is in the range from 2 to 70%.

9. Medium according to claim 1, exhibiting a birefringence in the range from 0.08 or more to 0.35 or more.

10. Light modulation element utilizing the flexoelectric effect comprising a medium according to claim 1.

11. Light modulation element according to claim 10, wherein the light modulation is induced by an applied in-plane electric field

12. The light modulation element according to claim 10, wherein the induced retardation in the “on”-state is in the range from 1 nm to 500 nm.

13. (canceled)

14. Electro-optical device comprising the light modulation element according to claim 10.
